(19) United States
(12) Patent Application Publication
(10) Pub. No.: US 2026/0175217 A1
(43) Pub. Date: Jun. 25, 2026

(54) DROPLET SEPARATION DEVICE, SEPARATION SIGNAL GENERATION DEVICE, SEPARATION SIGNAL GENERATION METHOD, AND PROGRAM

(71) Applicants: The University of Tokyo, Tokyo (JP); Tokyo Medical University, Tokyo (JP)

(72) Inventors: Sadao Ota, Tokyo (JP); Yoshiyuki Tsuyama, Tokyo (JP); Yusuke Yoshioka, Tokyo (JP)

(73) Assignees: The University of Tokyo, Tokyo (JP); Tokyo Medical University, Tokyo (JP)

(21) Appl. No.: 19/125,698

(22) PCT Filed: Nov. 6, 2023
(86) PCT No.: PCT/JP2023/039873

§ 371 Date: Apr. 29, 2025

Related U.S. Application Data
(60) Provisional application No. 63/422,611, filed on Nov. 4, 2022.

(51) Int. Cl. B01L 3/00

(52) U.S. Cl. CPC B01L 3/502715; B01L 3/502746

(57) ABSTRACT

A droplet separation device includes a microchannel that has an upstream portion, a chamber portion which is provided downstream with respect to the upstream portion and has a cross sectional area larger than a cross sectional area of the upstream portion, a branch portion which is provided downstream with respect to the chamber portion, and two branch channels which are branched by the branch portion, where droplets flow together with a first fluid, a droplet interval adjustment channel that is connected to the upstream portion to join the upstream portion and allows a second fluid having the same formulation as the first fluid to flow into the upstream portion, an electric field generation electrode that is provided to be adjacent to the chamber portion and generates an electric field by being controlled by an external signal to apply a voltage, and a plurality of reference electrodes that are provided to generate an electric field gradient in the chamber portion in accordance with the generation of the electric field by the electric field generation electrode, in which the branch portion has an asymmetric shape in which the droplets flow into only one of the two branch channels without being crushed in a case where the electric field generation electrode generates no electric field.

Priority is claimed on U.S. Provisional Application No. 63/422,611, filed Nov. 4, 2022, the content of which is incorporated herein by reference.

### TECHNICAL FIELD

The present invention relates to a separation signal generation device, a separation signal generation method, and a program.

### BACKGROUND ART

With a microfluidic system using droplets having a diameter of 100 micrometers or less, it is possible to compartmentalize molecules or particles, chemical reactions, or bioassays in a volume of nanoliters or less. High-speed screening of drug molecules and single-cell analysis have been realized using the microfluidic system. In a case of performing the above-described analysis, it may be necessary to measure a content or a state of individual droplets, to selectively separate the droplets, and to perform further operations or analysis.

As a method of separating droplets in a microfluidic device, a method using a dielectrophoresis phenomenon has been widely used (for example, Patent Document 1). In the separation method using the dielectrophoresis phenomenon, an electrode is prepared in a vicinity of a microchannel having a branch, and a voltage is applied to the electrode in a case where droplets to be separated pass through the vicinity of the electrode, thereby generating an electric field. The droplets to be separated are separated by changing the path of the droplets to be separated due to the dielectrophoresis phenomenon caused by the generated electric field. In the separation method using the dielectrophoresis phenomenon, by adjusting the interval between the droplets, the speed of the droplets, the applied voltage, the flow channel structure, and the electrode structure, the droplets can be selectively separated without splitting the droplets and fusing the droplets with other droplets.

The high-speed droplet separation is important for enabling shortening of the total analysis time, discovery and analysis of rare events from a large population, and preparation of various large amounts of subsets for analysis in the latter part. For example, in order to perform gene expression analysis or gene function analysis on extracellular vesicles which are much smaller than cells, it is necessary to prepare a subset of approximately 106 to 107 particles. In order to achieve this, it is necessary to measure approximately 107 to 108 droplets for several tens of minutes to several hours and selectively separate droplets containing the fine particles as an analysis target from the measured droplets.

### CITATION LIST

### Patent Document

Patent Document 1: Japanese Unexamined Patent Application, First Publication No. 2014-178119

### SUMMARY OF INVENTION

### Technical Problem

However, it is difficult to achieve both high-speed droplet separation and accuracy of the separation. This is because an increase in droplet processing rate is inevitably accompanied by an increase in speed of the droplets in the flow path or a decrease in the interval between the droplets. A dielectrophoresis time required for the separation is not sufficient in the microchannel having a branch due to the increase in speed of the droplets in the former flow channel, and thus it is difficult to carry out the separation itself. Due to the reduction in the interval between the droplets in the latter case, it is difficult to selectively separate only the droplet as a separation target from the adjacent droplets in the direction of the flow velocity. On the other hand, since the separation performance greatly depends on fluid conditions and distribution of the electric field generated by the electrode, a droplet separation device having various flow channel structures and electrode structures has been proposed. However, in the droplet separation devices in the related art, the separation rate is approximately several thousand droplets per second. A droplet separation device which realizes separation of 30,000 droplets per second by setting a channel height of a branch portion in a microchannel lower than the periphery is also known, but since the method requires a complicated flow path structure and deformation of droplets, there are problems in versatility and stability.

As described above, the droplet separation device in the related art, using a microchannel device, has a problem in that the high-speed droplet separation has insufficient versatility and stability. There is a demand for a droplet separation device which achieves both high-speed droplet separation and accuracy of separation with a simple configuration.

The present invention has been made in view of the above-described points, and provides a separation signal generation device, a separation signal generation method, and a program capable of achieving both high-speed droplet separation and accuracy of the separation by a simple configuration.

### Solution to Problem

The present invention has been made in order to solve the above-described problems, and an aspect of the present invention is a droplet separation device including a microchannel that has an upstream portion, a chamber portion which is provided downstream with respect to the upstream portion and has a cross sectional area larger than a cross sectional area of the upstream portion, a branch portion which is provided downstream with respect to the chamber portion, and two branch channels which are branched by the branch portion, where droplets flow together with a first fluid; a droplet interval adjustment channel that is connected to the upstream portion to join the upstream portion and allows a second fluid having the same formulation as the first fluid to flow into the upstream portion; an electric field generation electrode that is provided to be adjacent to the chamber portion and generates an electric field by being controlled by an external signal to apply a voltage; and a plurality of reference electrodes that are provided to generate an electric field gradient in the chamber portion in accordance with the generation of the electric field by the electric field generation electrode, in which the branch portion has an asymmetric shape in which the droplets flow into only one of the two branch channels without being crushed in a case where the electric field generation electrode generates no electric field.

In addition, as one aspect of the present invention, in the above-described droplet separation device, a distance between a connecting portion where the droplet interval adjustment channel is connected to the upstream portion and the chamber portion is a distance obtained by multiplying an interval between the droplets on an upstream side of the upstream portion with respect to the connecting portion by the ratio of the flow rate at the upstream side of the upstream portion with respect to the connecting portion and the flow rate at a downstream side of the upstream portion with respect to the connecting portion.

In addition, as one aspect of the present invention, in the above-described droplet separation device, a width of an inlet portion which is a portion of the chamber portion on a most upstream side is approximately equal to a diameter of the droplets, and the width of an outlet portion which is a portion of the chamber portion on a most downstream side is approximately equal to the sum of twice the diameter of the droplets and the width of the branch portion.

In addition, as one aspect of the present invention, in the above-described droplet separation device, a cross sectional area of the chamber portion is a cross sectional area corresponding to a cross sectional area of the upstream portion and the flow rate of the second fluid which is allowed to flow into the upstream portion by the droplet interval adjustment channel.

In addition, as one aspect of the present invention, in the above-described droplet separation device, a length of the chamber portion is a length which is determined according to the flow velocity at a downstream side of the upstream portion with respect to a connecting portion where the droplet interval adjustment channel is connected to the upstream portion, in which the number of the droplets flowing through the chamber portion at the same time is 1 in terms of time average.

In addition, as one aspect of the present invention, in the above-described droplet separation device, a width of the branch portion is approximately equal to or less than the diameter of the droplets.

In addition, as one aspect of the present invention, in the above-described droplet separation device, as a shape of a portion of the branch portion on a most upstream side, a portion on one side of the two branch channels, where the droplets flow in the case where the electric field generation electrode generates no electric field, is curved.

In addition, as one aspect of the present invention, in the above-described droplet separation device, a tip part of the electric field generation electrode and a first side surface of the chamber portion face each other, an orientation of a surface of the tip part is substantially parallel to an orientation of the first side surface, and the area of the surface of the tip part is approximately equal to the area of the first side surface.

In addition, as one aspect of the present invention, in the above-described droplet separation device, a part of the plurality of the reference electrodes is provided adjacent to the electric field generation electrode on a side of the microchannel on which the electric field generation electrode is provided, and the remaining part of the plurality of reference electrodes is provided on a side of the microchannel on which no electric field generation electrode is provided.

In addition, as one aspect of the present invention, in the above-described droplet separation device, a width of the microchannel is approximately equal to the diameter of the droplets in a portion other than the chamber portion.

In addition, an aspect of the present invention is a separation signal generation device including a first trigger signal generation unit that generates a first trigger signal at a time when a separation target is detected, the separation target being wrapped in a droplet and flowing through a microchannel together with a first fluid; a second trigger signal generation unit that generates a second trigger signal at a time when the droplet flowing through the microchannel passes through a predetermined position in a flow velocity direction of the microchannel; a determination unit that determines whether or not a determination signal which is the sum of the magnitude of the first trigger signal and the magnitude of the second trigger signal is equal to or more than a predetermined threshold value; and a separation signal output unit that outputs a separation signal for separating the separation target in a case where the determination signal is equal to or more than the threshold value.

In addition, as one aspect of the present invention, in the above-described separation signal generation device, the passing of the droplet flowing through the microchannel through the position in the flow velocity direction of the microchannel is detected based on scattered light from the droplet flowing through the microchannel.

In addition, an aspect of the present invention is a separation signal generation method including a first trigger signal generation step of generating a first trigger signal at a time when a separation target is detected, the separation target being wrapped in a droplet and flowing through a microchannel together with a first fluid; a second trigger signal generation step of generating a second trigger signal at a time when the droplet flowing through the microchannel passes through a predetermined position in a flow velocity direction of the microchannel; a determination step of determining whether or not a determination signal which is the sum of the magnitude of the first trigger signal and the magnitude of the second trigger signal is equal to or more than a predetermined threshold value; and a separation signal output step of outputting a separation signal for separating the separation target in a case where the determination signal is equal to or more than the threshold value.

In addition, an aspect of the present invention is program which causes a computer to execute a first trigger signal generation step of generating a first trigger signal at a time when a separation target is detected, the separation target being wrapped in a droplet and flowing through a microchannel together with a first fluid; a second trigger signal generation step of generating a second trigger signal at a time when the droplet flowing through the microchannel passes through a predetermined position in a flow velocity direction of the microchannel; a determination step of determining whether or not a determination signal which is the sum of the magnitude of the first trigger signal and the magnitude of the second trigger signal is equal to or more than a predetermined threshold value; and a separation signal output step of outputting a separation signal for separating the separation target in a case where the determination signal is equal to or more than the threshold value.

### Advantageous Effects of Invention

According to the present invention, it is possible to achieve both high-speed droplet separation and accuracy of the separation by a simple configuration.

### BRIEF DESCRIPTION OF DRAWINGS

FIG. 1 A plan view showing the configuration of a microchannel chip according to the embodiment of the present invention.

FIG. 2 A plan view showing a schematic configuration of the microchannel chip according to the embodiment of the present invention.

FIG. 3 A view showing an example of an outline of detection of a measurement sample by a measurement sample detection device according to the embodiment of the present invention.

FIG. 4 A view showing an example of an outline of alignment of the measurement sample in an alignment portion according to the embodiment of the present invention.

FIG. 5 A diagram showing performance of focus by the alignment portion according to the embodiment of the present invention.

FIG. 6 A diagram showing an example of a change in time of a signal intensity of fluorescence from the measurement sample detected by a detector according to the embodiment of the present invention.

FIG. 7 A diagram showing an example of the number of counts of the measurement sample with respect to the signal intensity according to the embodiment of the present invention.

FIG. 8 A plan view showing a schematic configuration of a droplet separation unit according to the embodiment of the present invention.

FIG. 9 A plan view of the droplet separation unit of the present embodiment according to the embodiment of the present invention.

FIG. 10 An enlarged plan view of a periphery of a chamber portion according to the embodiment of the present invention.

FIG. 11 A view showing a three-dimensional model of a microchannel used in a simulation of an electric field gradient according to the embodiment of the present invention.

FIG. 12 A diagram showing a calculation result of the electric field gradient calculated by the simulation of the electric field gradient according to the embodiment of the present invention.

FIG. 13 A diagram showing an outline of determination of a condition for performing separation based on a measurement signal according to the embodiment of the present invention.

FIG. 14 A diagram showing an outline of detection of the measurement signal according to the embodiment of the present invention.

FIG. 15 A diagram showing an outline of signal processing relating to output of the separation signal according to the embodiment of the present invention.

FIG. 16 A diagram showing an example of a functional configuration of the separation signal generation device according to the embodiment of the present invention.

FIG. 17 A diagram showing an example of a flow of separation signal generation processing according to the embodiment of the present invention.

FIG. 18 A diagram showing an example of an optical system according to the embodiment of the present invention.

FIG. 19 A diagram showing actual measurement values of each of a signal detection signal, a determination signal, and a separation signal according to the embodiment of the present invention.

FIG. 20 A view showing an example of a result of imaging a state of generating droplets according to the embodiment of the present invention.

FIG. 21 A view showing a result of imaging a state of droplets flowing through a microchannel in a state in which a voltage is not applied to an electric field generation electrode according to the embodiment of the present invention.

FIG. 22 A view showing a result of imaging a state of droplets flowing through a microchannel in a state in which a voltage of 1,000 volts is applied to the electric field generation electrode according to the embodiment of the present invention.

FIG. 23 A view showing a result of separation at a time interval of 50 microseconds according to the embodiment of the present invention.

FIG. 24 A view showing a time series of captured images in a case where the images are separated at a time interval of 50 microseconds according to the embodiment of the present invention.

FIG. 25 A view showing a result of separation at a time interval of 100 microseconds according to the embodiment of the present invention.

FIG. 26 A view showing a time series of captured images in a case where the images are separated at a time interval of 100 microseconds according to the embodiment of the present invention.

FIG. 27 A diagram showing a result of separation in a case where a time from detection of a signal detection signal to generation of a first trigger signal is shifted according to the embodiment of the present invention.

FIG. 28 A histogram showing, for each measurement sample, how many frames before the frame in which the measurement sample is detected is a frame from which the frame is separated according to the embodiment of the present invention.

FIG. 29 A diagram showing separation accuracy with respect to a separation delay time according to the embodiment of the present invention.

FIG. 30 A diagram showing results of separation of nanoparticles using a droplet detection device according to the embodiment of the present invention.

FIG. 31 A view showing results of evaluating separation performance according to the embodiment of the present invention.

FIG. 32 A diagram showing a proportion of the number of counted separation targets to the number of counted droplets according to the embodiment of the present invention.

FIG. 33 A diagram showing a detection result in a case where two kinds of nanoparticles are used before separation is performed according to the embodiment of the present invention.

FIG. 34 A diagram showing a detection result in a case where two kinds of nanoparticles are used after separation is performed according to the embodiment of the present invention.

FIG. 35 A diagram showing a result of separation of extracellular vesicles according to the embodiment of the present invention.

FIG. 36 A view showing an image obtained by imaging a state in which the separation of extracellular vesicles is performed according to the embodiment of the present invention.

### DESCRIPTION OF EMBODIMENTS

### Embodiment

Hereinafter, embodiments of the present invention will be described in detail with reference to drawings. In the present embodiment, unless otherwise specified, the fact that a certain amount is approximately equal to other amount means that a difference between the certain amount and the other amount is within 20% of the other amount.

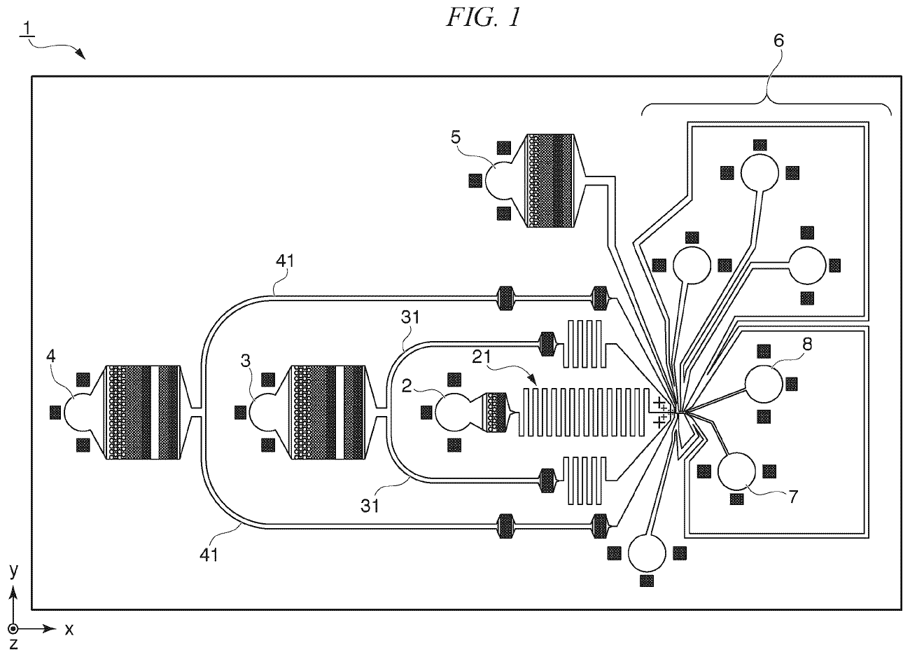

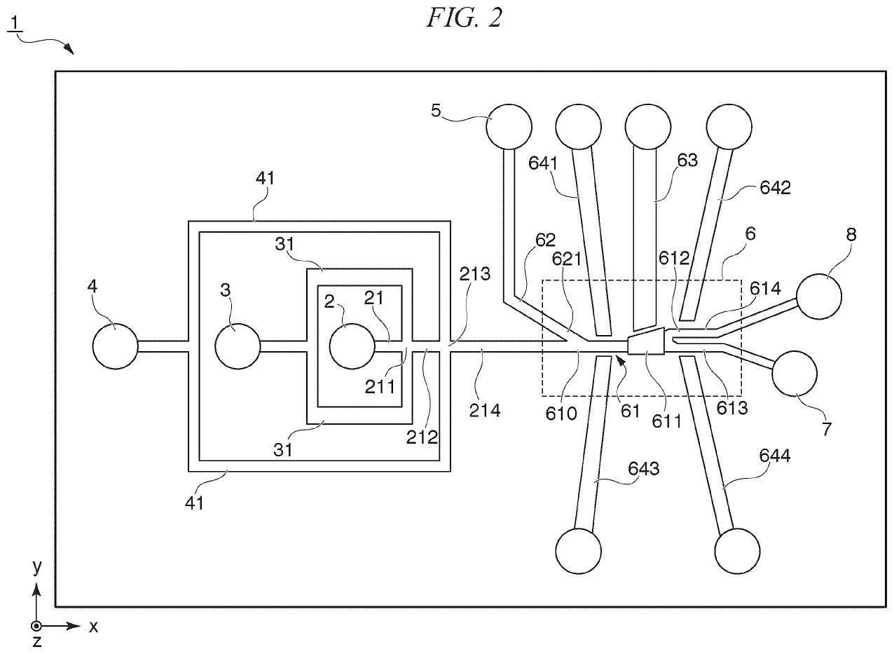

FIG. 1 is a plan view showing the configuration of a microchannel chip 1 according to the present embodiment. FIG. 2 is a plan view showing a schematic configuration of the microchannel chip 1 according to the present embodiment.

The microchannel chip 1 includes a sample flow supply unit 2, a sample channel 21, a first sheath liquid supply unit 3, a first sheath liquid inflow path 31, a first oil supply unit 4, an oil inlet path 41, a second oil supply unit 5, and a droplet separation unit 6.

In the drawings, an xyz coordinate system is shown as a three-dimensional orthogonal coordinate system as appropriate. In the present embodiment, the y-axis direction is a width direction of the sample channel 21. In addition, the x-axis direction is a length direction of the sample channel 21. The length direction of the sample channel 21 is also referred to as a channel direction of the sample channel 21, a flow direction of a sample flow, or the like. The z-axis direction is a direction orthogonal to the sample channel 21 and is a height direction of the sample channel 21. In the present embodiment, a bottom surface of the sample channel 21 does not change in the height of the sample channel 21 in the channel direction. In the flow of liquid in the sample channel 21, a measurement sample A1 is moved in the +x direction of the x-axis direction. A width direction of the sample channel 21 is, in other words, a direction perpendicular to a flow line of fluid flowing together with the measurement sample A1.

One end part of the sample channel 21 communicates with the sample flow supply unit 2. The other end part of the sample channel 21 communicates with the droplet separation unit 6. A sample flow F1 is supplied from the sample flow supply unit 2 and flows from one end part to the other end part of the sample channel 21.

A downstream end of the sample flow F1 in the flow direction of the sample flow supply unit 2 communicates with an upstream end of the sample flow F1 in the flow direction of the sample channel 21. The sample flow supply unit 2 supplies the sample flow F1 to the sample channel 21. The sample flow F1 is a fluid containing a plurality of measurement samples A1 (also referred to as measurement targets). The amount of the sample flow F1 supplied by the sample flow supply unit 2 per unit time is 0.2 microliters per minute.

The measurement sample A1 is a fine particle. In the present embodiment, a diameter of the fine particle is 1 nanometer or less. That is, the measurement sample A1 is a nanoparticle. The measurement sample A1 is, for example, an extracellular vesicle or a fine bead (for example, a polystyrene bead).

The first sheath liquid inflow path 31 is formed side by side with the sample channel 21. Two first sheath liquid inflow paths 31 are formed. The two first sheath liquid inflow paths 31 are formed symmetrically with the sample channel 21 interposed therebetween. A first sheath liquid B1 flows through the first sheath liquid inflow path 31. In the first sheath liquid B1, an alignment portion 211 aligns the measurement sample A1 in one row and continuously flows the measurement sample A1.

The first sheath liquid B1 flows through the first sheath liquid inflow path 31 in the same direction as the sample flow F1 from an upstream side to a downstream side of the sample flow F1 in the flow direction. The two first sheath liquid inflow paths 31 communicate with each other at upstream ends and downstream ends of the first sheath liquid B1 in the flow direction. The downstream ends of the two first sheath liquid inflow paths 31 communicate with the alignment portion 211 of the sample channel 21.

The first sheath liquid supply unit 3 is provided at an upstream end of the two first sheath liquid inflow paths 31. In the first sheath liquid supply unit 3, the upstream ends of the two first sheath liquid supply units 3 are communicated with each other. The first sheath liquid supply unit 3 supplies the first sheath liquid B1 to the two first sheath liquid supply units 3. The amount of the first sheath liquid B1 supplied by the first sheath liquid supply unit 3 per unit time is 2 microliters per minute.

A detection portion 212 is provided on a downstream side of the alignment portion 211. The detection portion 212 is a portion of the sample channel 21 in which the measurement sample A1 is detected. A measurement sample detection device 9 (not shown) is provided in the vicinity of the detection portion 212. The measurement sample detection device 9 is an individual device separate from the microchannel chip 1. The measurement sample detection device 9 includes, for example, a laser light source, a detector, a control unit, and the like.

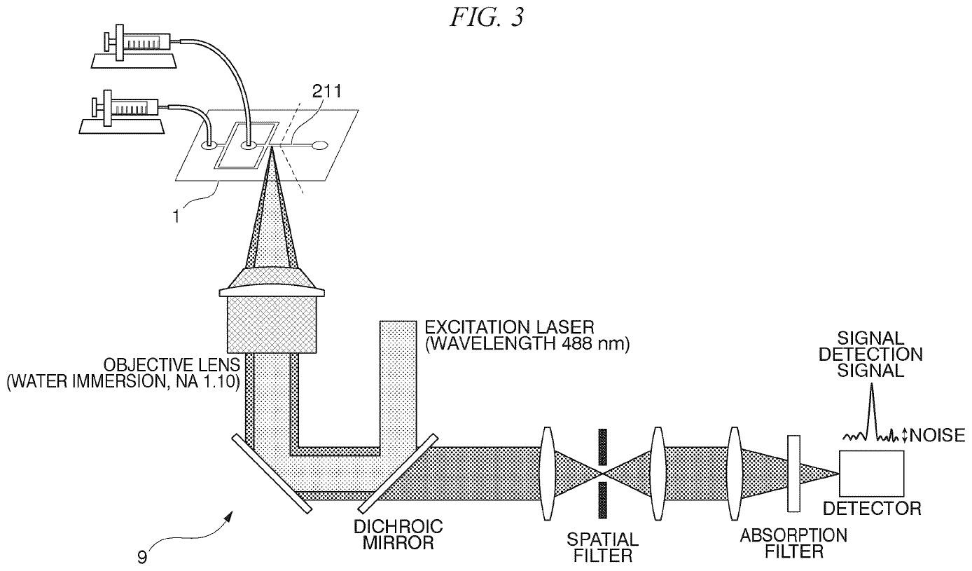

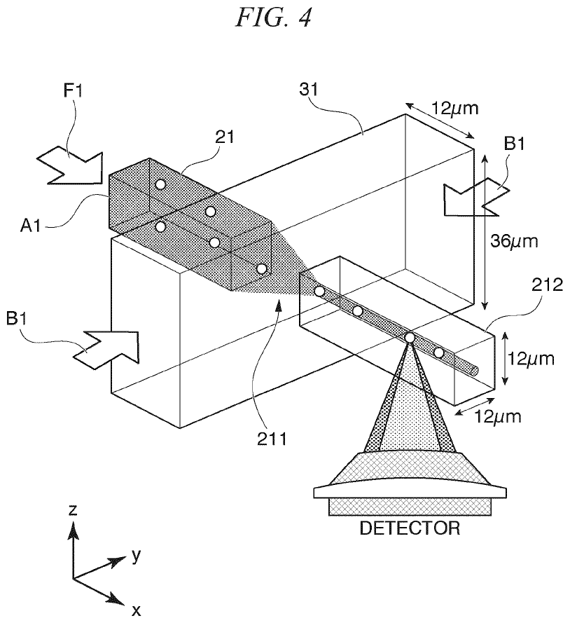

Here, the alignment of the measurement sample A1 in the alignment portion 211 and the detection of the measurement sample A1 by the measurement sample detection device 9 will be described with reference to FIGS. 3 to 7. FIG. 3 is a diagram showing an example of an outline of the detection of the measurement sample A1 by the measurement sample detection device 9 according to the present embodiment. FIG. 4 is a diagram showing an example of an outline of the alignment of the measurement sample A1 in the alignment portion 211 according to the present embodiment.

The alignment portion 211 rectifies the sample flow F1 based on a hydro-focusing technology. The alignment portion 211 focuses the sample flow F1 on a center of the sample channel 21 based on the hydro-focusing technology. Here, the center of the sample channel 21 is a center of the sample channel 21 in each of the height direction and the width direction. Therefore, the alignment portion 211 performs the rectification of the sample flow F1 in each of the height direction and the width direction of the sample channel 21. The rectification by the alignment portion 211 is also referred to as three-dimensional focusing. The sample channel 21 communicates with the first sheath liquid inflow path 31 in the alignment portion 211. Here, a height (depth) of the first sheath liquid inflow path 31 is higher than a height of the sample channel 21. The sample channel 21 communicates with the first sheath liquid inflow path 31 at a position at the center in the height direction of the first sheath liquid inflow path 31.

In the alignment portion 211, the first sheath liquid B1 flows in from both side surface directions of the sample channel 21. The sample flow F1 is focused on the center of the sample channel 21 by the inflowed first sheath liquid B1. As shown in FIG. 4, on the upstream side of the sample channel 21 with respect to the alignment portion 211, the measurement sample A1 varies in each of the height direction and the width direction.

On the downstream side with respect to the alignment portion 211, the variation of the position of the measurement sample A1 in each of the height direction and the width direction of the sample channel 21 is suppressed. That is, the position of the measurement sample A1 is aligned in each of the height direction and the width direction of the sample channel 21 by focusing the sample flow F1 on the center of the sample channel 21. In the alignment portion 211, the sample flow F1 is focused on the center of the sample channel 21 without being substantially diluted by the inflow of the first sheath liquid B1. The sample flow F1 flowing downstream of the alignment portion 211 flows through the sample channel 21 together with the first sheath liquid B1, but the sample flow F1 flowing downstream of the alignment portion 211 together with the first sheath liquid B1 is also referred to as the sample flow F1.

Next, the detection of the measurement sample A1 by the measurement sample detection device 9 will be described. The measurement sample A1 aligned by the alignment portion 211 flows through the sample channel 21 together with the sample flow F1, and reaches the detection portion 212 downstream of the alignment portion 211. In the detection portion 212, the measurement sample detection device 9 detects the measurement sample A1.

The measurement sample detection device 9 detects the measurement sample A1 flowing through the sample channel 21 together with the sample flow F1. The measurement sample detection device 9 detects, by the detector, fluorescence or scattered light, which is generated from the measurement sample A1 by irradiation with laser light, and acquires, for example, information related to the measurement sample A1. In the present embodiment, the measurement sample detection device 9 detects the fluorescence generated from the measurement sample A1. A cell information acquisition device 300 discriminates a separation target A2 from among the plurality of measurement samples A1 contained in the sample flow F1 by the control unit, based on the acquired information. In a case where the control unit detects the separation target A2, the control unit outputs a signal (referred to as a signal detection signal SS1) indicating that the separation target A2 has been detected to the droplet separation unit 6.

The measurement sample detection device 9 includes an irradiation optical system which is an optical system for irradiating the measurement sample A1 with laser light, and includes a detection optical system which is an optical system for detecting the fluorescence or scattered light generated from the measurement sample A1 by a detector. The irradiation optical system includes an optical element such as a dichroic mirror and an objective lens, and a laser light source. The detection optical system includes an optical element such as an objective lens, a dichroic mirror, and a filter, and a detector. The optical element may be shared between the irradiation optical system and the detection optical system. The wavelength of the laser emitted from the laser light source is, for example, 488 nm. The detector provided in the measurement sample detection device 9 is, for example, a photomultiplier tube (PMT). The measurement sample detection device 9 may have a function of discriminating feature of the separation target A2 by machine learning.

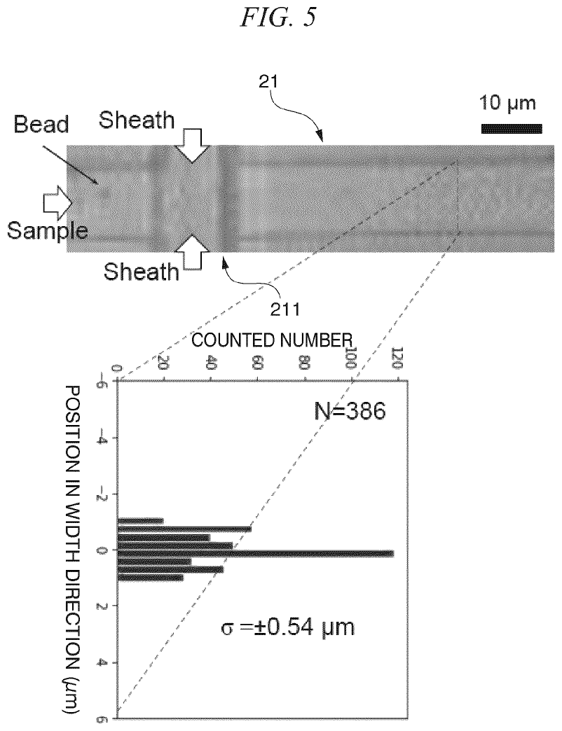

FIG. 5 shows performance of focus by the alignment portion 211. As described above, the sample flow F1 is focused on the center of the sample channel 21 by allowing the first sheath liquid B1 to flow into the sample channel 21. The graph shown in FIG. 5 is a histogram showing a distribution of positions of the measurement sample A1 in the width direction of the sample channel 21, which has passed through a position downstream of the alignment portion 211. According to the graph, it is found that the variation from the center of the position of the measurement sample A1 in the width direction is suppressed to 2 micrometers or less.

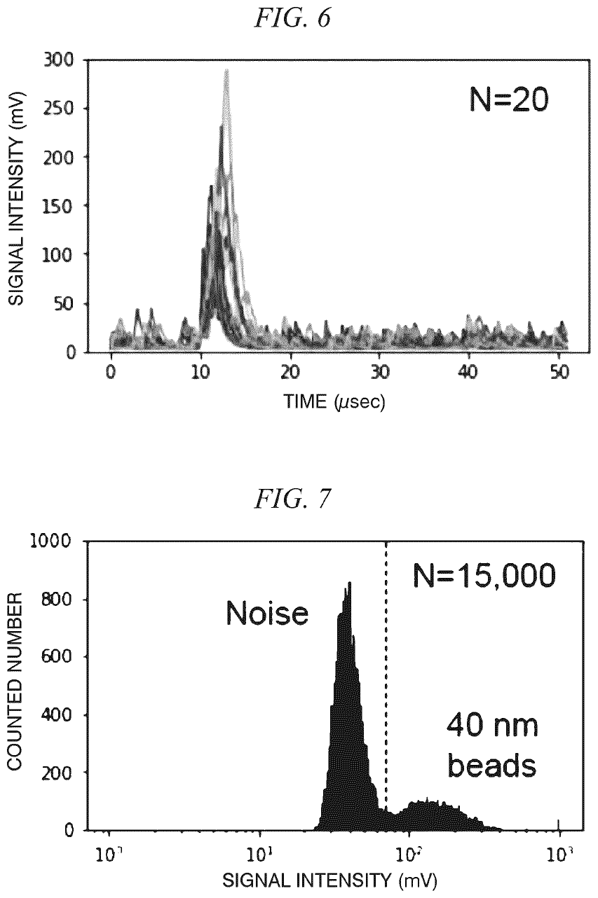

FIG. 6 shows an example of a change in time of a signal intensity of the fluorescence from the measurement sample A1 detected by the detector. The result shown in FIG. 6 is a detection result obtained by using fluorescent beads having a diameter of 40 nanometers for the measurement sample A1. The number of the measurement samples A1 is 20. FIG. 7 shows an example of the number of counts of the measurement sample A1 with respect to the signal intensity. The result shown in FIG. 7 is a detection result obtained by using fluorescent beads having a diameter of 40 nanometers for the measurement sample A1, as in FIG. 6. The number of the measurement samples A1 is 15,000. According to the histogram shown in FIG. 7, it is found that the measurement sample detection device 9 can discriminate between the separation target A2 and a non-separation target A3 for the 15,000 measurement samples A1.

The description of the configuration of the microchannel chip 1 will be continued with reference to FIGS. 1 and 2.

The oil inlet path 41 is formed side by side with the first sheath liquid inflow path 31. Two oil inlet paths 41 are formed. The two oil inlet paths 41 are formed symmetrically with the first sheath liquid inflow path 31 interposed therebetween. A first oil C1 flows through the oil inlet path 41.

The first oil C1 flows through the oil inlet path 41 in the same direction as the sample flow F1 from the upstream side to the downstream side of the sample flow F1 in the flow direction. The two oil inlet paths 41 communicate with each other at upstream ends and downstream ends of the first oil C1 in the flow direction. The downstream ends of the two oil inlet paths 41 communicate with a droplet generation portion 213 of the sample channel 21.

The first oil C1 forms droplets D1 which wrap the sample flow F1 in the droplet generation portion 213. As the droplets D1, there are the droplet D1 containing the measurement sample A1 and the droplet D1 not containing the measurement sample A1, depending on a time when the measurement sample A1 reaches a position of the droplet generation portion 213 and a time when the droplet D1 is formed. The first oil C1 and the droplet D1 flowing downstream of the droplet generation portion 213 are collectively referred to as a phase-separated fluid G1. The first oil C1 corresponds to a continuous phase fluid. The droplet D1 corresponds to a dispersed phase fluid.

The first oil supply unit 4 is provided at upstream ends of the two oil inlet paths 41. The first oil supply unit 4 communicates with the upstream ends of the two oil inlet paths 41. The first oil supply unit 4 supplies the first oil C1 to the two oil inlet paths 41. The amount of the first oil C1 supplied by the first oil supply unit 4 per unit time is 12 microliters per minute.

The second oil supply unit 5 is provided at an upstream end of a droplet interval adjustment channel 62. The second oil supply unit 5 supplies a second oil E1 to the droplet interval adjustment channel 62. The amount of the second oil E1 supplied by the second oil supply unit 5 per unit time is 20 microliters per minute.

The droplet separation unit 6 separates the droplet D1 surrounding the separation target A2, among the droplets D1. The droplet separation unit 6 includes a microchannel 61, a droplet interval adjustment channel 62, an electric field generation electrode 63, and a plurality of reference electrodes 64.

A waste liquid side discharge port 7 is provided at a downstream end of a waste liquid side channel 613. The phase-separated fluid G1 including the droplet D1 not separated by the droplet separation unit 6 flows through the waste liquid side discharge port 7. The phase-separated fluid G1 which has passed through the waste liquid side discharge port 7 is discharged to a test tube (not shown) or the like disposed on the downstream side of the downstream end of the waste liquid side discharge port 7.

A separation side discharge port 8 is provided at a downstream end of a separation side channel 614. The phase-separated fluid G1 including the droplet D1 separated by the droplet separation unit 6 flows through the separation side discharge port 8. The phase-separated fluid G1 which has passed through the separation side discharge port 8 is discharged to a test tube (not shown) or the like disposed on the downstream side of the downstream end of the separation side discharge port 8.

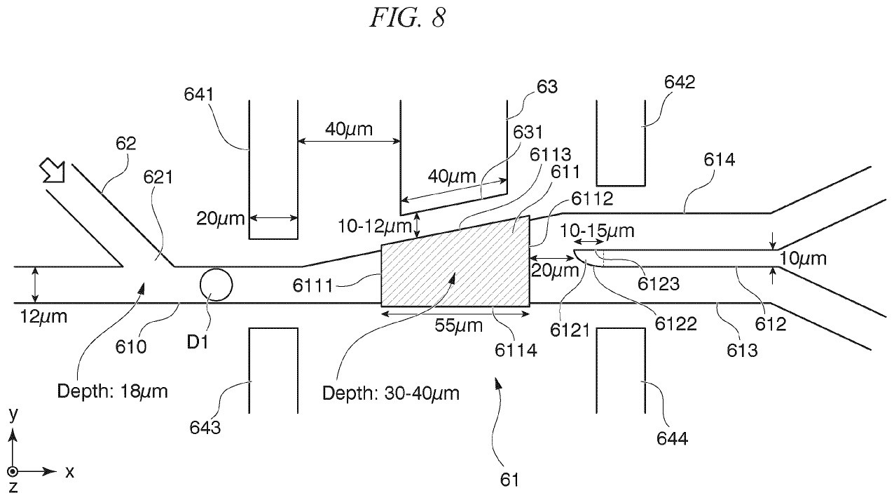

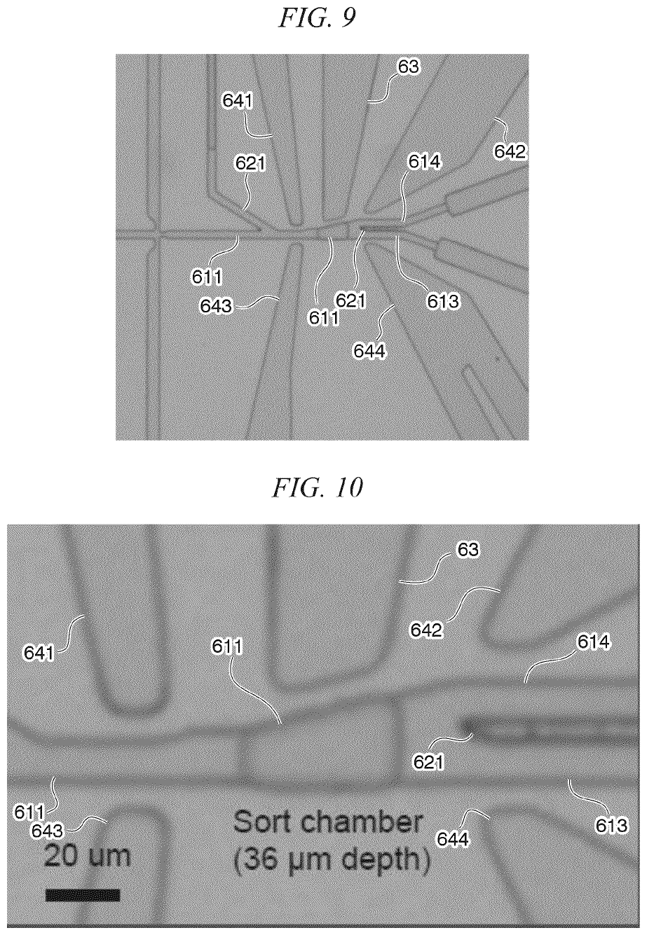

Here, details of the configuration of the droplet separation unit 6 will be described with reference to FIGS. 8 to 10. FIG. 8 is a plan view showing a schematic configuration of the droplet separation unit 6 according to the present embodiment. FIG. 9 is a plan view of the droplet separation unit 6 according to the present embodiment.

The droplet D1 flows together with the first oil C1 in the microchannel 61. The measurement sample A1 is wrapped in the droplet D1, and flows through the microchannel 61 together with the first oil C1. The first oil C1 flows through the sample channel 21 as a continuous phase fluid. The droplet D1 flows through the sample channel 21 as a dispersed phase fluid. The microchannel 61 communicates with the sample channel 21 on the upstream side.

The microchannel 61 has an upstream portion 610, a chamber portion 611, a branch portion 612, a waste liquid side channel 613, and a separation side channel 614. The upstream portion 610, the chamber portion 611, and the branch portion 612 are provided in this order from the upstream side to the downstream side. Therefore, the chamber portion 611 is provided downstream of the upstream portion 610. The branch portion 612 is provided downstream of the chamber portion 611. The waste liquid side channel 613 and the separation side channel 614 are provided on the downstream side of the branch portion 612. The waste liquid side channel 613 and the separation side channel 614 are two branch channels branched by the branch portion 612.

The droplet interval adjustment channel 62 is connected to the upstream portion 610 so as to join the upstream portion 610. The droplet interval adjustment channel 62 allows the second oil E1 to flow into the upstream portion 610. The second oil E1 is a fluid having the same formulation as the first oil C1. The first oil C1 is an example of a first fluid, and the second oil E1 is an example of a second fluid.

The droplet interval adjustment channel 62 allows the second oil E1 to flow into the upstream portion 610 to finely adjust a speed of the droplet D1 flowing through the microchannel 61 and an interval between the droplets D1. The interval between the droplets D1 is an interval between the droplets D1 adjacent to each other in the channel direction of the sample channel 21 among the plurality of the droplets D1 flowing through the sample channel 21. The fine adjustment of the speed of the droplet D1 is to increase the speed of the droplet D1 flowing together with the first oil C1 in the microchannel 61 by a predetermined proportion with respect to a flow velocity of the phase-separated fluid G1 in a case where the droplet interval adjustment channel 62 is not provided, by a proportion according to the flow rate of the second oil E1. Similarly, the fine adjustment of the interval between the droplets D1 is to change the interval with respect to an interval between the droplets D1 in a case where the droplet interval adjustment channel 62 is not provided, by the proportion corresponding to the flow rate of the second oil E1.

The chamber portion 611 has a width larger than that of the upstream portion 610. The chamber portion 611 has a depth deeper than the upstream portion 610. That is, the chamber portion 611 has a cross sectional area larger than that of the upstream portion 610. By setting the cross sectional area of the microchannel 61 to be larger than that of the upstream portion 610, the droplets D1 flowing together with the first oil C1 in the microchannel 61 as the phase-separated fluid G1 is decelerated. Here, the cross sectional area of each portion of the microchannel 61, such as the chamber portion 611 and the upstream portion 610, is an area of a cross section perpendicular to the channel direction of the microchannel 61.

The electric field generation electrode 63 is provided adjacent to the chamber portion 611, and generates an electric field by being controlled by an external signal to apply a voltage. The plurality of reference electrodes 64 are provided to generate an electric field gradient in the chamber portion 611 in accordance with the generation of the electric field by the electric field generation electrode 63. The electric field gradient is a locally high gradient such that the droplet D1 can be separated by a dielectrophoretic force. For example, the plurality of reference electrodes 64 consist of a first reference electrode 641, a second reference electrode 642, a third reference electrode 643, and a fourth reference electrode 644.

The branch portion 612 has an asymmetric shape in which the droplet D1 flows into only in the waste liquid side channel 613 out of the waste liquid side channel 613 and the separation side channel 614 without being crushed in a case where the electric field generation electrode 63 does not generate an electric field.

A width of each of the upstream portion 610, the separation side channel 614, and the waste liquid side channel 613 is approximately equal to the diameter of the droplet D1. That is, the width of the microchannel 61 is approximately equal to the diameter of the droplet D1 in a portion other than the chamber portion 611. In the present embodiment, the width of each of the upstream portion 610, the separation side channel 614, and the waste liquid side channel 613 is 12 micrometers. With the configuration, the droplet D1 flowing through the microchannel 61 is less likely to be crushed at the branch portion 612, and is easily separated.

The width of the microchannel 61 may not be approximately equal to the diameter of the droplet D1 in a portion other than the chamber portion 611. However, in order to make it difficult for the droplet D1 flowing through the microchannel 61 to be crushed and to make it easy to separate the droplet D1 at the branch portion 612, it is preferable that the width of the microchannel 61 is approximately equal to the diameter of the droplet D1 in a portion other than the chamber portion 611.

Here, a more detailed configuration of the droplet interval adjustment channel 62 will be described. The droplet interval adjustment channel 62 is connected to the upstream portion 610 at a connecting portion 621. The connecting portion 621 is a portion where the droplet interval adjustment channel 62 is connected to the upstream portion 610. Here, a distance between the connecting portion 621 and the chamber portion 611 is a distance (referred to as a first distance) obtained by multiplying the interval between the droplets D1 on the upstream side of the upstream portion 610 with respect to the connecting portion 621 by the ratio of the flow rate at the upstream side of the upstream portion 610 with respect to the connecting portion 621 and the flow rate at the downstream side of the upstream portion 610 with respect to the connecting portion 621.

By setting the distance between the connecting portion 621 and the chamber portion 611 to the first distance, the distance from a droplet detection portion 214 to the droplet separation unit 6 can be made as short as possible, and a time from the detection of the droplet D1 to the separation of the droplet D1 can be made as short as possible. In addition, by setting the distance between the connecting portion 621 and the chamber portion 611 to the first distance, influence of the electric field generated by the electric field generation electrode 63 on the droplet D1 adjacent to the droplet D1 to be separated in the channel direction of the sample channel 21 can be minimized in a case where the droplet D1 to be separated is separated. The droplet D1 adjacent to the droplet D1 to be separated is both the droplet D1 flowing on the upstream side of the droplet D1 to be separated and the droplet D1 flowing on the downstream side of the droplet D1 to be separated.

The distance between the connecting portion 621 and the chamber portion 611 may be longer than the first distance, or may be shorter than the first distance. However, as described above, in order to simultaneously achieve shortening of the time from the detection of the droplet D1 to the separation of the droplet D1 and reduction of the influence of the electric field on the droplet D1 adjacent to the droplet D1 to be separated, it is preferable that the distance between the connecting portion 621 and the chamber portion 611 is set to the first distance.

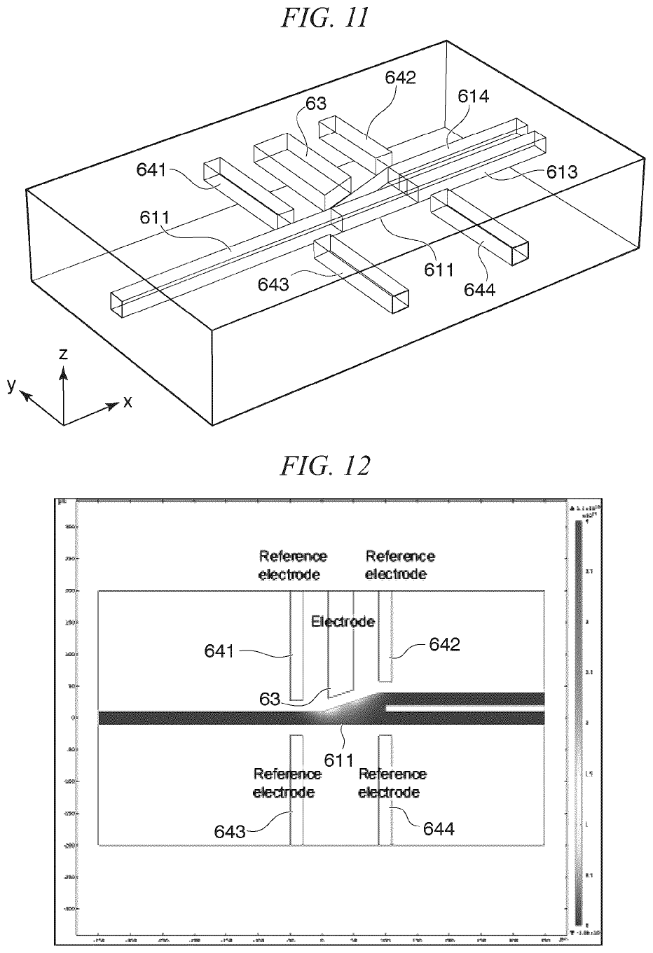

Next, a more detailed configuration of the chamber portion 611 will be described. A shape of the chamber portion 611 is a trapezoid in a case where the microchannel chip 1 is viewed from above. FIG. 10 is an enlarged plan view of a periphery of the chamber portion 611. An inlet portion 6111 is a portion of the chamber portion 611 on the most upstream side. An outlet portion 6112 is a portion of the chamber portion 611 on the most downstream side. The inlet portion 6111 corresponds to an upper side of the trapezoid in the plan view. The outlet portion 6112 corresponds to a lower side of the trapezoid in the plan view. A first side surface 6113 and a second side surface 6114, which are side surfaces constituting the chamber portion 611, correspond to a leg of the trapezoid, respectively. A first side surface 6113 faces an electrode tip part 631 which is a tip portion of the electric field generation electrode 63.

A width of the inlet portion 6111 is approximately equal to the diameter of the droplet D1. In the present embodiment, the diameter of the droplet D1 is approximately 10 micrometers (from 9 micrometers to 12 micrometers). A width of the outlet portion 6112 is approximately equal to the sum of twice the diameter of the droplet D1 and a width of the branch portion 612. The width of the branch portion 612 is 10 micrometers. Therefore, the sum of twice the diameter of the droplet D1 and the width of the branch portion 612 is 34 micrometers.

A bottom surface of the chamber portion 611 is deeper than a bottom surface of the upstream portion 610. A ceiling of the chamber portion 611 is the same height as a ceiling of the upstream portion 610. A depth of the chamber portion 611 is a depth of approximately 2 to 3 times a depth of the upstream portion 610. In the present embodiment, the depth of the upstream portion 610 is 18 micrometers. Therefore, the depth of the chamber portion 611 is 30 micrometers to 40 micrometers. By setting the depth of the chamber portion 611 to be approximately 2 to 3 times the depth of the upstream portion 610, the droplet D1 can be temporarily decelerated in the chamber portion 611 in which the dielectrophoretic force works strongly.

The length of the chamber portion 611 is a length which is determined according to the flow velocity on the downstream side of the connecting portion 621, in which the number of the droplets D1 flowing through the chamber portion 611 at the same time is 1 in terms of time average. With the configuration, it is possible to suppress the droplet D1 to be separated and another droplet D1 adjacent to the droplet D1 in the channel direction of the microchannel 61 from being erroneously separated. In the present embodiment, the length of the chamber portion 611 is 55 micrometers.

In the droplet separation unit 6 according to the present embodiment, depending on the configuration of the chamber portion 611 described above, the dielectrophoretic force can be sufficiently large to act on the droplet D1 while increasing the speed of the droplet D1 flowing through the microchannel 61 as a whole of the microchannel 61.

The configuration (shape and size) of the chamber portion 611 is not limited to the above-described configuration as long as the cross sectional area of the chamber portion 611 is larger than the cross sectional area of the upstream portion 610. For example, the ceiling of the chamber portion 611 may be higher than the ceiling of the upstream portion 610, and the bottom surface of the chamber portion 611 may be at the same depth as the bottom surface of the upstream portion 610. The ceiling of the chamber portion 611 may be higher than the ceiling of the upstream portion 610, and the bottom surface of the chamber portion 611 may be deeper than the bottom surface of the upstream portion 610.

In addition, the ceiling of the chamber portion 611 may be at the same height as the ceiling of the upstream portion 610, the bottom surface of the chamber portion 611 may be at the same depth as the bottom surface of the upstream portion 610, and the width of the chamber portion 611 may be larger than the width of the upstream portion 610.

The depth of the chamber portion 611 may be a depth other than the depth approximately 2 to 3 times the depth of the upstream portion 610. In a case where the depth of the chamber portion 611 is deeper than the depth approximately 2 to 3 times the depth of the upstream portion 610, the droplet D1 is decelerated more than in the present embodiment. In this case, by increasing the flow rate of the second oil E1 flowing into the droplet interval adjustment channel 62, the degree of deceleration of the droplet D1 in the chamber portion 611 can be set to be the same as that in the present embodiment. On the other hand, in a case where the depth of the chamber portion 611 is shallower than the depth approximately 2 to 3 times the depth of the upstream portion 610, the droplet D1 is not decelerated as much as in the present embodiment. In this case, by decreasing the flow rate of the second oil E1 flowing into the droplet interval adjustment channel 62, the degree of deceleration of the droplet D1 in the chamber portion 611 can be set to be the same as that in the present embodiment.

Therefore, it is preferable that the cross sectional area of the chamber portion 611 is a cross sectional area corresponding to the cross sectional area of the upstream portion 610 and the flow rate of the second oil E1 which is allowed to flow into the upstream portion 610 by the droplet interval adjustment channel 62. By adjusting the cross sectional area of the chamber portion 611 according to the cross sectional area of the upstream portion 610 and the flow rate of the second oil E1, the speed of the droplet D1 in the chamber portion 611 can be set to a desired speed for causing the dielectrophoretic force to be sufficiently large for the droplet D1 during the separation. The cross sectional area of the chamber portion 611 may not be the cross sectional area corresponding to the cross sectional area of the upstream portion 610 and the flow rate of the second oil E1 which is allowed to flow into the upstream portion 610 by the droplet interval adjustment channel 62.

In addition, the shape of the chamber portion 611 may be a shape other than the trapezoid shown in FIG. 8. The shape of the chamber portion 611 may be a shape which is line-symmetrical in the channel direction. For example, the shape of the chamber portion 611 may be a so-called isosceles trapezoid in which lengths of non-parallel sides are equal and internal angles at both ends of a base are equal.

Next, a more detailed configuration of the branch portion 612 will be described. The width of the branch portion 612 is approximately equal to or less than the diameter of the droplet D1. The width of the branch portion 612 is an interval between two branch channels branched by the branch portion 612. In the present embodiment, the width of the branch portion 612 is 10 micrometers.

A branch tip part 6121 of the branch portion 612 is the most upstream portion of the branch portion 612. Depending on whether the width of the branch portion 612 is approximately equal to as or less than the diameter of the droplet D1, the branch tip part 6121 has a shape in which sharpness is suppressed against the flowing droplet D1.

The branch tip part 6121 is composed of a waste liquid-side side surface 6122 and a separation-side side surface 6123. The waste liquid-side side surface 6122 is a side surface on the side of the waste liquid side channel 613 among side surfaces constituting the branch tip part 6121. The separation-side side surface 6123 is a side surface on the side of the separation side channel 614 among the side surfaces constituting the branch tip part 6121. The waste liquid-side side surface 6122 is a gentle curved surface. On the other hand, the separation-side side surface 6123 is a flat surface. In the plan view shown in FIG. 8, the waste liquid-side side surface 6122 has a shape of a gentle curve, and the separation-side side surface 6123 has a shape of a straight line. Therefore, the branch tip part 6121 of the branch portion 612 has an asymmetric shape.

As described above, in the plan view, the waste liquid-side side surface 6122 has a shape of a gentle curve. The gentle curve is, for example, a shape which is convex (convex in the +y direction of the y-axis direction) on the side of the waste liquid side channel 613 as shown in FIG. 8. The shape of the waste liquid-side side surface 6122 is not limited to the shape shown in FIG. 8 as long as the condition that only the waste liquid side channel 613 out of the waste liquid side channel 613 and the separation side channel 614 flows without the droplet D1 being crushed is satisfied in a case where the electric field generation electrode 63 does not generate an electric field. The condition is achieved by the degree of sharpness of the branch tip part 6121 being equal to or less than a predetermined value. For example, the shape of the waste liquid-side side surface 6122 may be a curved surface other than the curved surface shown in FIG. 8 (the curve in the plan view), a shape of a plane (a straight line in the plan view), or a shape consisting of a plurality of planes (a broken line in the plan view). In a case where the shape of the waste liquid-side side surface 6122 is a shape consisting of a plurality of flat surfaces, it is preferable that a corner of a portion where the plurality of flat surfaces are connected to each other is rounded.

Therefore, in the shape of the most upstream portion (branch tip part 6121) of the branch portion 612, out of the two branch channels (the waste liquid side channel 613 and the separation side channel 614), the portion (waste liquid-side side surface 6122) on the side of the one (waste liquid side channel 613) through which the droplet D1 flows in a case where the electric field generation electrode 63 does not generate an electric field is curved.

In addition, the shape of the branch tip part 6121 of the branch portion 612 is a shape in which a resistance ratio between the waste liquid side channel 613 and the separation side channel 614 is approximately 1:1.1 to 1:1.2. The shape of the branch tip part 6121 of the branch portion 612 may be a shape in which the resistance ratio between the waste liquid side channel 613 and the separation side channel 614 is a ratio other than the ratio of approximately 1:1.1 to 1:1.2.

The configuration of the branch portion 612 described above, allows the droplet D1 to flow, in a case where the electric field generation electrode 63 does not generate an electric field, only in the waste liquid side channel 613 out of the two branch channels (in the present embodiment, the waste liquid side channel 613 and the separation side channel 614) without being crushed and without being fused with another droplet D1 flowing adjacent to the droplet D1 in the channel direction.

Next, more detailed configurations of the electric field generation electrode 63 and the plurality of the reference electrodes 64 will be described. As described above, the electrode tip part 631 which is a tip portion of the electric field generation electrode 63 faces the first side surface 6113 of the chamber portion 611. The orientation of the surface of the electrode tip part 631 is substantially parallel to an orientation of the first side surface 6113. In the plan view shown in FIG. 8, the orientation of the surface of the electrode tip part 631 and the orientation of the first side surface 6113 are each oblique. In addition, the area of the surface of the electrode tip part 631 is approximately equal to an area of the first side surface 6113.

A part (the first reference electrode 641 and the second reference electrode 642) of the plurality of the reference electrodes 64 is provided adjacent to the electric field generation electrode 63 on a side of the microchannel 61 where the electric field generation electrode 63 is provided. On the other hand, a remaining part (the third reference electrode 643 and the fourth reference electrode 644) of the plurality of the reference electrodes 64 is provided on a side of the microchannel 61 where the electric field generation electrode 63 is not provided. The first reference electrode 641 is provided to face the third reference electrode 643 with the microchannel 61 interposed therebetween. The second reference electrode 642 is provided to face the fourth reference electrode 644 with the microchannel 61 interposed therebetween.

With the above-described configuration, a locally high electric field gradient can be generated in the entire chamber portion 611 to the extent that the droplet D1 can be separated by the dielectrophoretic force. As described above, in the present embodiment, the length of the chamber portion 611 is the length at which the number of the droplets D1 flowing through the chamber portion 611 at the same time is 1 in terms of time average. Therefore, the fact that a locally high electric field gradient can be generated in the entire chamber portion 611 means that a locally high electric field gradient can be generated for a spread of about the interval between the droplets D1.

Here, FIGS. 11 and 12 show results of calculating the electric field gradient generated by the electric field generation electrode 63 and the plurality of the reference electrodes 64 by simulation. FIG. 11 is a diagram showing a three-dimensional model of the microchannel 61 used in the simulation of the electric field gradient. FIG. 12 is a calculation result of the electric field gradient calculated by the simulation of the electric field gradient. COMSOL (registered trademark) Multiphysics is used for the simulation of the electric field gradient. According to the result shown in FIG. 12, it is found that a locally high electric field gradient is generated in the chamber portion 611.

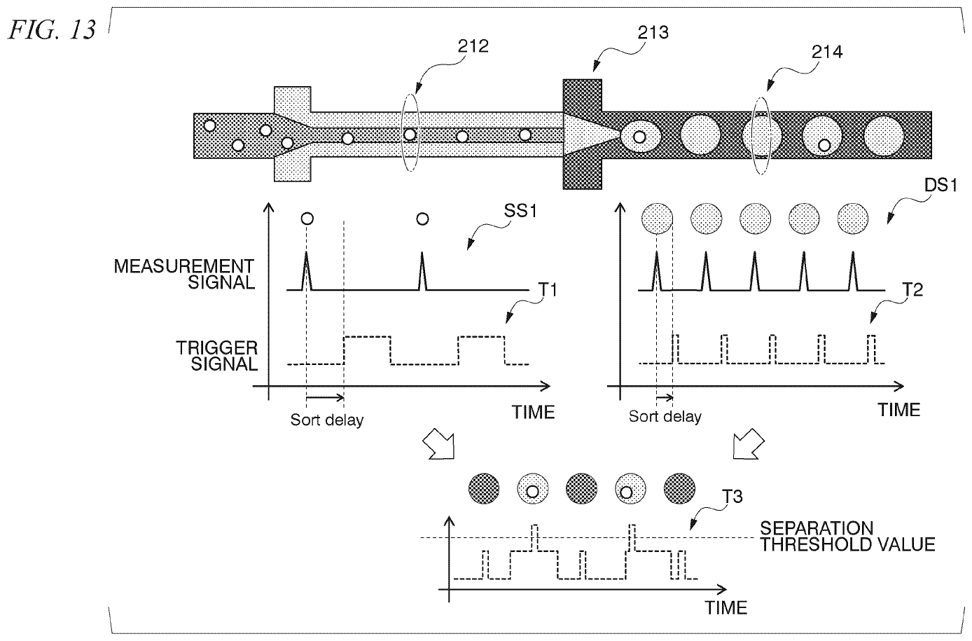

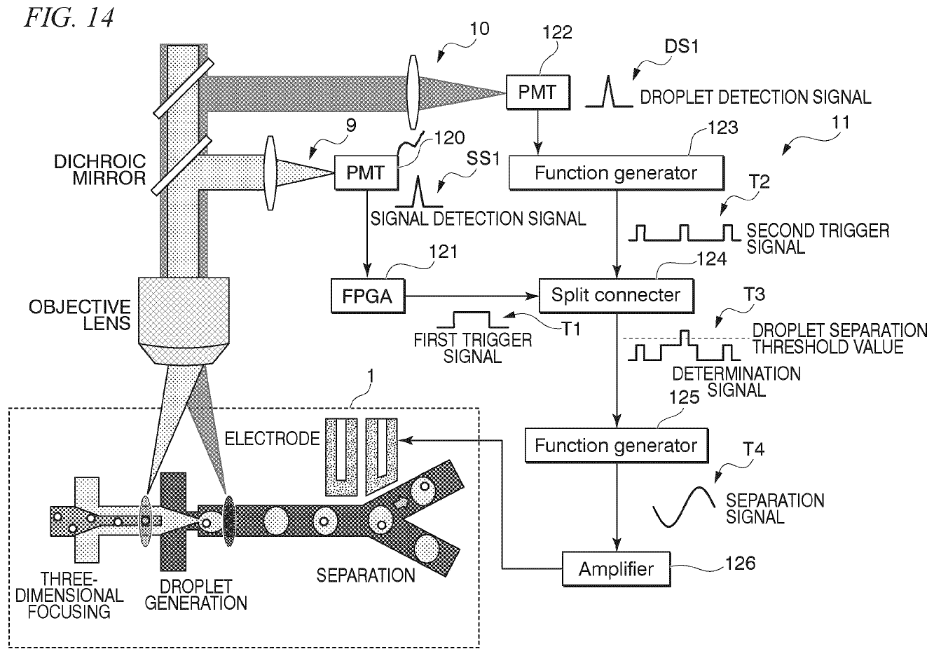

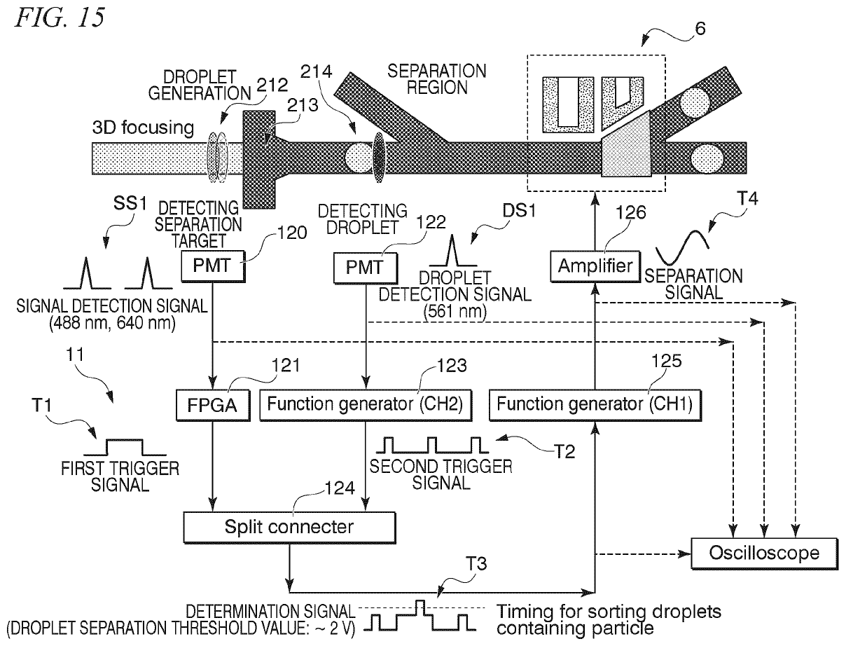

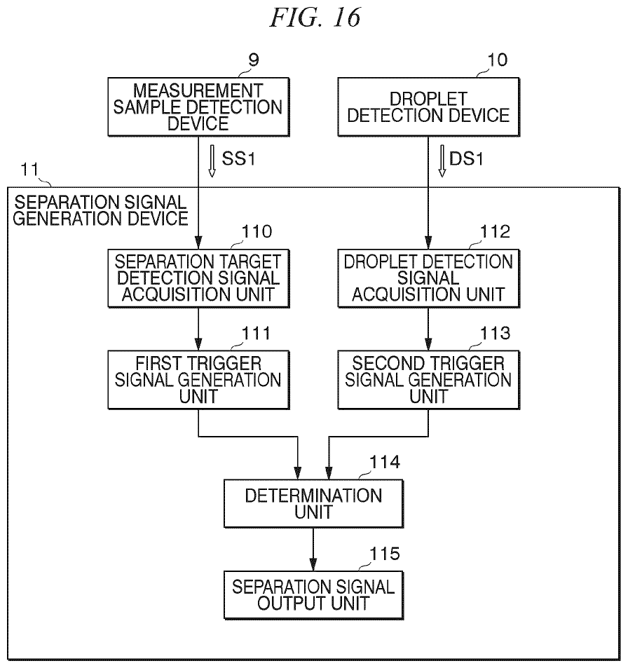

The disposition of the electric field generation electrode 63 and the plurality of the reference electrodes 64 and the number of the plurality of the reference electrodes 64 are merely examples and are not limited thereto. As long as the locally high electric field gradient can be generated in the chamber portion 611, other configurations may be used as the disposition of the electric field generation electrode 63 and the plurality of the reference electrodes 64 and the number of the plurality of the reference electrodes 64. Next, a process of separating the droplet D1 based on the time when each of the separation target A2 and the droplet D1 is detected will be described with reference to FIGS. 13 to 17. FIG. 13 is a diagram showing an outline of determination of a condition for performing the separation based on a measurement signal. FIG. 14 is a diagram showing an outline of detection of the measurement signal according to the present embodiment. FIG. 15 is a diagram showing an outline of signal processing relating to output of the separation signal according to the present embodiment.

The measurement sample detection device 9 detects the separation target A2 flowing through the microchannel 61 in the detection portion 212. As described above, the position of the detection portion 212 is on the upstream side of the sample channel 21 with respect to the droplet generation portion 213.

In a case where the measurement sample detection device 9 detects the separation target A2, the measurement sample detection device 9 generates a signal detection signal SS1 as a measurement signal. The signal detection signal SS1 is a signal indicating the change in time of the signal intensity of fluorescence from the measurement sample A1, as shown in FIG. 6. The fluorescence from the separation target A2 is detected by a PMT 120. In a case where the signal detection signal SS1 exceeds a predetermined threshold value, a separation signal generation device 11 generates a first trigger signal T1. The first trigger signal T1 is a pulse signal which rises in response to the signal detection signal SS1 exceeding the predetermined threshold value. The first trigger signal T1 is generated by an FPGA 121.

The time when the pulse of the first trigger signal T1 rises is synchronized with a time when the separation target A2 is detected. However, there is a time delay between the time when the separation target A2 is detected and the time when the pulse of the first trigger signal T1 rises by a time of the processing by the FPGA 121.

A droplet detection device 10 detects the droplet D1 flowing through the microchannel 61 in the droplet detection portion 214. As described above, the position of the droplet detection portion 214 is on the downstream side of the sample channel 21 with respect to the droplet generation portion 213. Therefore, the time when the droplet D1 is detected is a time after the separation target A2 is detected.

In a case where the droplet D1 is detected, the droplet detection device 10 generates a droplet detection signal DS1 as a measurement signal. The droplet detection signal DS1 is a signal indicating a temporal change in time of the signal intensity of the scattered light from the droplet D1. The scattered light from the droplet D1 is detected by a PMT 122. In a case where the droplet detection signal DS1 exceeds a predetermined threshold value, the separation signal generation device 11 generates a second trigger signal T2. The second trigger signal T2 is a pulse signal which rises in response to the droplet detection signal DS1 exceeding the predetermined threshold value. The second trigger signal T2 is generated by a function generator 123.

The time when the pulse of the second trigger signal T2 rises is synchronized with a time when the droplet D1 is detected. However, there is a time delay between the time when the droplet D1 is detected and the time when the pulse of the second trigger signal T2 rises by a time of the processing by the function generator 123.

In a case where a determination signal T3 which is the sum of the first trigger signal T1 and the second trigger signal T2 is equal to or more than a predetermined threshold value (referred to as a separation threshold value), the separation signal generation device 11 outputs a separation signal T4 for separating the separation target A2. The separation signal T4 is an external signal for controlling application of a voltage to the electric field generation electrode 63. Here, the first trigger signal T1 output from the FPGA 121 and the second trigger signal T2 output from the function generator 123 are combined by a split connector 124 and output to a function generator 125 as a determination signal T3. The function generator 125 performs determination as to whether or not the determination signal T3 is equal to or more than the separation threshold value. In a case where it is determined that the determination signal T3 is equal to or more than the separation threshold value, the function generator 125 outputs the separation signal T4 to an amplifier 126. The separation signal T4 amplified by the amplifier 126 is output to the electric field generation electrode 63 as an external signal for controlling the application of a voltage to the electric field generation electrode 63.

Here, a relationship between a pulse width of the first trigger signal T1 and a time interval TD1 for which the droplet D1 passes through the droplet detection portion 214 of the sample channel 21 will be described. The time interval TD1 is a time interval between the time at which droplets D1 adjacent to each other in the flow velocity direction pass through a predetermined position (the position of the droplet detection portion 214).

In the present embodiment, as an example, the pulse width of the first trigger signal T1 is shorter than the time interval TD1. With the configuration, among the droplets D1, only the droplet D1 containing the separation target A2 can be separated.

Here, in a case where the pulse width of the first trigger signal T1 is longer than the time interval TD1, the pulse of the second trigger signal T2, which is generated in accordance with the detection of the next droplet D1 adjacent to the droplet D1 containing the separation target A2 in the channel direction, and the pulse of the first trigger signal T1 may overlap each other. In this case, even in a case where the separation target A2 is not detected in the next droplet D1, the determination signal T3 exceeds the separation threshold value, and the separation is performed.

On the other hand, in a case where the pulse width of the first trigger signal T1 is too narrow, the pulse of the first trigger signal T1 and the pulse of the second trigger signal T2 are unlikely to overlap each other. Consequently, even in a case where the droplet D1 containing the separation target A2 is detected, the droplet D1 may not be separated.

In the present embodiment, although an example of a case where the droplet D1 containing the separation target A2 is separated after the separation target A2 is detected has been described, the present invention is not limited thereto. The droplet D1 may be separated regardless of the detection result of the separation target A2. In this case, the droplet D1 to be separated includes the droplet D1 containing the separation target A2 and the droplet D1 not containing the separation target A2. After the droplet D1 is discharged from the separation side discharge port 8, the droplet D1 is destroyed, and then the separation target A2 contained in the droplet D1 is collected. The separation of the droplet D1 regardless of the detection result of the separation target A2 is suitable in a case where the droplet D1 is desired to be separated as much as possible, even in a case where the separation target A2 cannot be discriminated.

In a case where the droplet D1 is to be separated regardless of the detection result of the separation target A2, the pulse width of the first trigger signal T1 may be longer than the time interval TD1. With the configuration, since the pulse of the first trigger signal T1 and the pulse of the second trigger signal T2 are likely to overlap each other in time, the detected droplet D1 is likely to be separated.

In the present embodiment, an example of a case where the second trigger signal T2 is generated based on the droplet detection signal DS1 has been described. That is, although an example of a case where the second trigger signal T2 is generated in response to the detection of the scattered light from the droplet D1 has been described, the present invention is not limited thereto. The second trigger signal T2 may be generated based on a period in which the droplet D1 is generated. In the droplet generation portion 213, the period in which the droplet D1 is generated is determined to some extent according to the flow rate of the first oil C1 from the oil inlet path 41 and the flow rate of the sample flow F1 in the sample channel 21. Accordingly, the period in which the droplet D1 is generated may be acquired in advance, and the second trigger signal T2 may be generated based on the period. In this case, the configuration of the droplet detection device 10 may be omitted.

FIG. 16 is a diagram showing an example of a functional configuration of the separation signal generation device 11 according to the present embodiment. The separation signal generation device 11 includes a separation target detection signal acquisition unit 110, a first trigger signal generation unit 111, a droplet detection signal acquisition unit 112, a second trigger signal generation unit 113, a determination unit 114, and a separation signal output unit 115.

The separation target detection signal acquisition unit 110 acquires the signal detection signal SS1 from the measurement sample detection device 9.

The first trigger signal generation unit 111 generates the first trigger signal T1 at the time when the separation target A2 wrapped in the droplet and flows through the microchannel 61 together with the first fluid (in the present embodiment, the first sheath liquid B1) is detected. The first trigger signal generation unit 111 includes the FPGA 121.

The droplet detection signal acquisition unit 112 acquires the droplet detection signal DS1 from the droplet detection device 10.

The second trigger signal generation unit 113 generates the second trigger signal T2 at the time when the droplet D1 flowing through the microchannel 61 passes through a predetermined position in the flow velocity direction of the microchannel 61. The second trigger signal generation unit 113 includes the function generator 123.

The determination unit 114 determines whether or not the determination signal T3 which is the sum of the first trigger signal T1 and the second trigger signal T2 is equal to or more than a predetermined threshold value (the separation threshold value). The determination unit 114 includes the function generator 125.

In a case where the determination signal T3 is equal to or more than the threshold value, the separation signal output unit 115 outputs the separation signal T4 for separating the separation target A2. The separation signal output unit 115 includes the function generator 125.

As described above, in a case where the second trigger signal T2 is generated based on the period in which the droplet D1 is generated, the separation signal generation device 11 stores the period in which the droplet D1 is generated in advance, and the second trigger signal generation unit 113 generates the second trigger signal T2 based on the stored period.

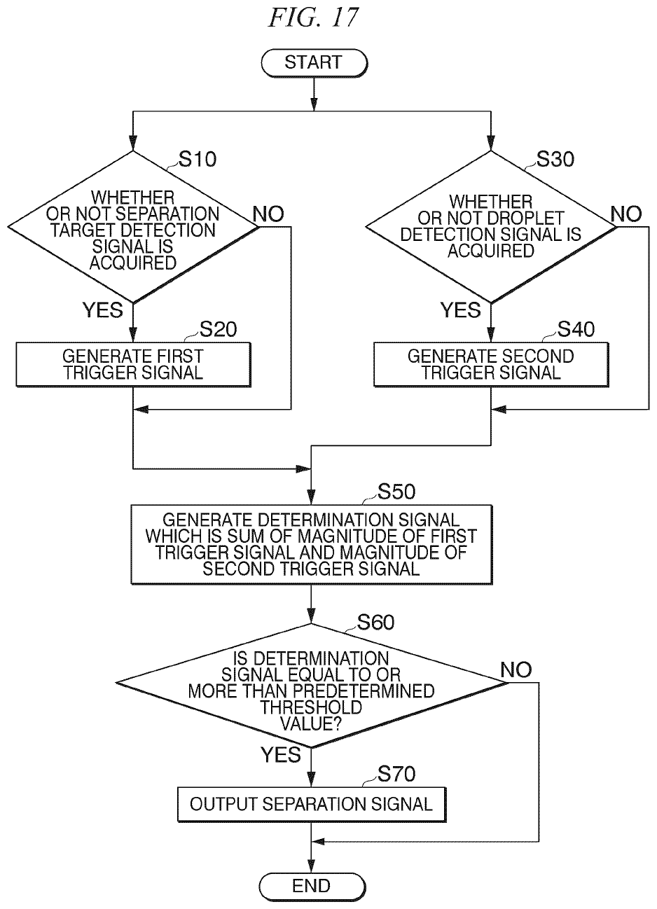

FIG. 17 is a diagram showing an example of a flow of the separation signal generation processing by the separation signal generation device 11 according to the present embodiment. The separation signal generation device 11 repeatedly executes the separation signal generation processing while a microfluidic device including the microchannel chip 1 is in operation.

Step S10: The first trigger signal generation unit 111 determines whether or not the separation target detection signal acquisition unit 110 acquires the signal detection signal SS1 from the measurement sample detection device 9. In a case where the first trigger signal generation unit 111 determines that the signal detection signal SS1 is acquired (step S10; YES), the first trigger signal generation unit 111 generates the first trigger signal T1 (step S20). Thereafter, the determination unit 114 executes the processing of a step S50. On the other hand, in a case where the first trigger signal generation unit 111 determines that the signal detection signal SS1 is not acquired (step S10; NO), the determination unit 114 executes the processing of the step S50.

Step S30: The second trigger signal generation unit 113 determines whether or not the droplet detection signal acquisition unit 112 acquires the droplet detection signal DS1 from the droplet detection device 10. In a case where the second trigger signal generation unit 113 determines that the droplet detection signal DS1 is acquired (step S30; YES), the second trigger signal generation unit 113 generates the second trigger signal T2. Thereafter, the determination unit 114 executes the processing of the step S50. On the other hand, in a case where the second trigger signal generation unit 113 determines that the droplet detection signal DS1 is not acquired (step S30; NO), the determination unit 114 executes the processing of the step S50.

Step S50: The determination unit 114 generates the determination signal T3 which is the sum of the first trigger signal T1 and the second trigger signal T2.

Step S60: The determination unit 114 determines whether or not the determination signal T3 is equal to or more than a predetermined threshold value (the separation threshold value). In a case where the determination unit 114 determines that the determination signal T3 is equal to or more than the separation threshold value (step S60; YES), the separation signal output unit 115 outputs the separation signal T4. The separation signal output unit 115 outputs the separation signal T4 to the electric field generation electrode 63 through the amplifier 126. On the other hand, in a case where the determination unit 114 determines that the determination signal T3 is not equal to or more than the separation threshold value (step S60; NO), the separation signal generation device 11 ends the separation signal generation processing.

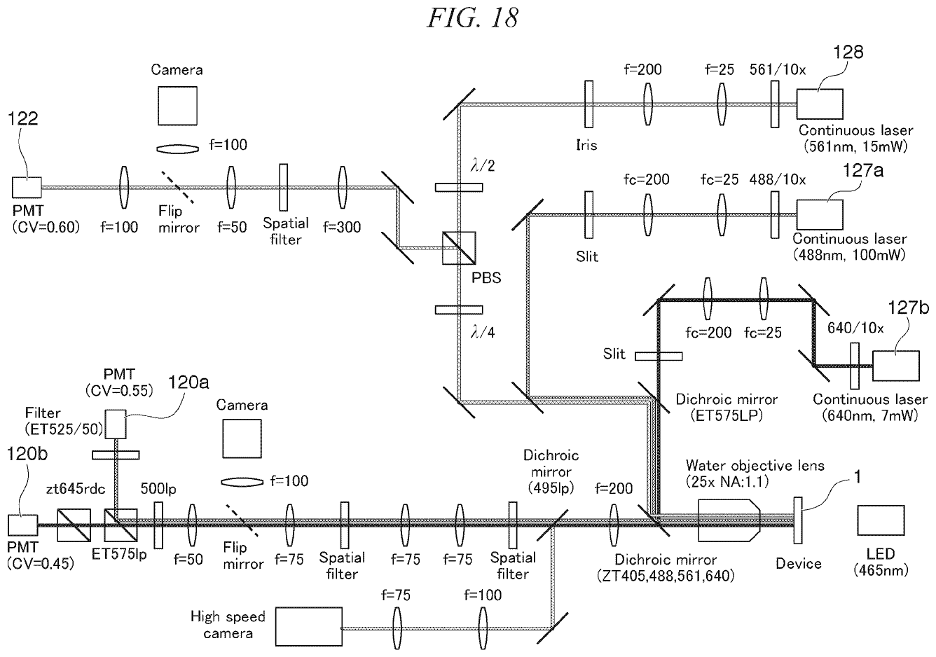

FIG. 18 is a diagram showing an example of an optical system according to the present embodiment. The optical system includes an irradiation optical system and a detection optical system. An optical element included in the irradiation optical system and an optical element included in the detection optical system may be included to be used in common. The optical system shown in FIG. 18 is an example, and an optical system other than the optical system shown in FIG. 18 may be used.

In the example shown in FIG. 18, the irradiation optical system includes two laser light sources, a laser light source 127a and a laser light source 127b, as light sources. In the measurement sample A1, the laser light of two types of wavelengths, that is, laser light of 488 nanometers and laser light of 640 nanometers, are respectively irradiated from the laser light source 127a and the laser light source 127b.

The detection optical system includes two detectors, a PMT 120a and a PMT 120b, as the PMT 120. The PMT 120a detects fluorescence from the measurement sample A1 irradiated with the laser light emitted from the laser light source 127a as excitation light. The PMT 120b detects fluorescence from the measurement sample A1 irradiated with the laser light emitted from the laser light source 127b as excitation light. In addition, the detection optical system includes a laser light source 128 and a PMT 122. The droplet D1 is irradiated with laser light having a wavelength of 561 nanometers from the laser light source 128. The PMT 122 detects scattered light in which the laser light from the laser light source 128 is scattered by the droplet D1.

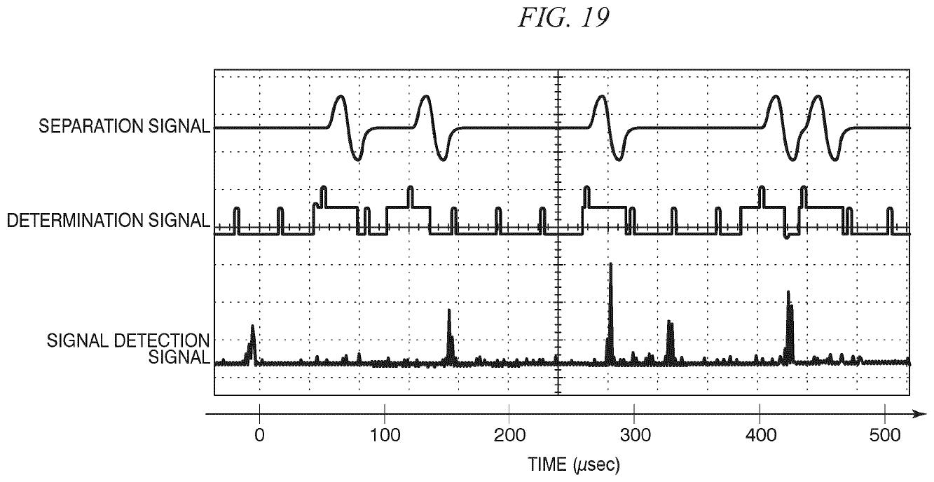

FIG. 19 shows actual measurement values of the signal detection signal SS1, the determination signal T3, and the separation signal T4. As described above, the determination signal T3 is the sum of the first trigger signal T1 synchronized with the signal detection signal SS1 and the second trigger signal T2 synchronized with the droplet detection signal DS1. As shown in FIG. 19, it is found that the divination signal T4 can be generated by the separation signal generation device 11 according to the present embodiment in synchronization with both the time point when the separation target A2 is detected and the time point when the droplet D1 is detected.

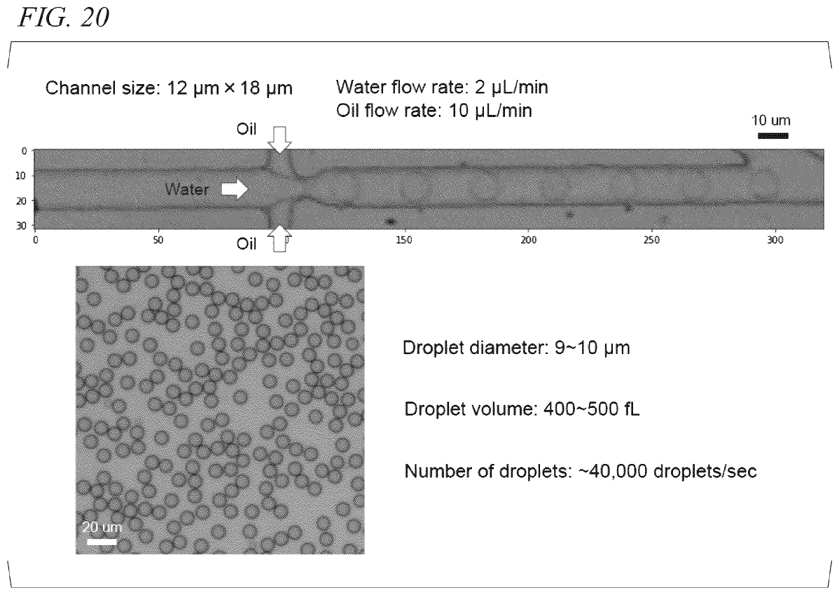

FIG. 20 is a view showing an example of a result of imaging a state of generating the droplets D1. The size of the microchannel is a width of 12 micrometers and a height of 18 micrometers. The flow velocity of water is 2 microliters per second. The flow velocity of the oil is 10 microliters per second. The diameter of the generated droplets D1 is 9 micrometers to 10 micrometers. The volume of the generated droplets D1 is 400 femtoliters to 500 femtoliters. The generation rate of the droplets D1 is 40,000 droplets per second.

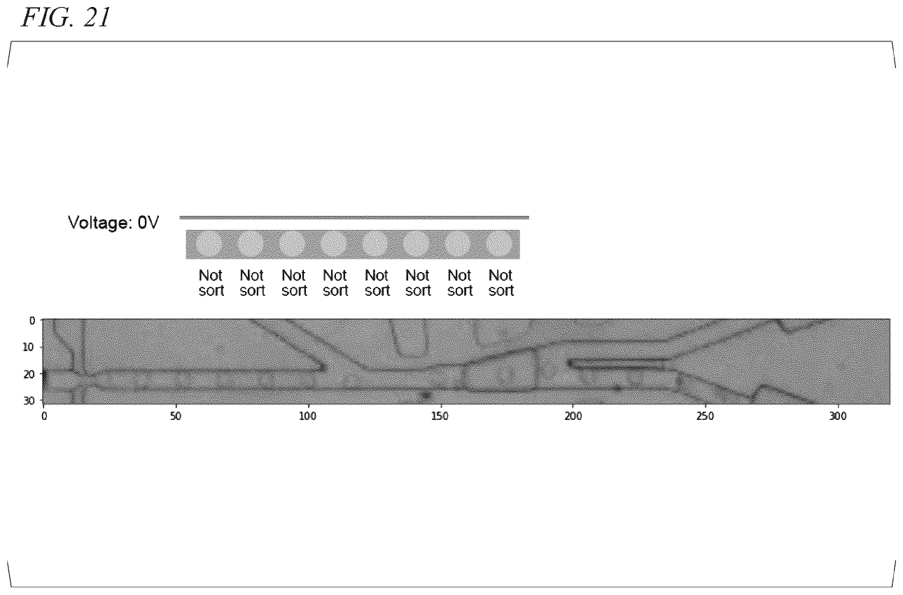

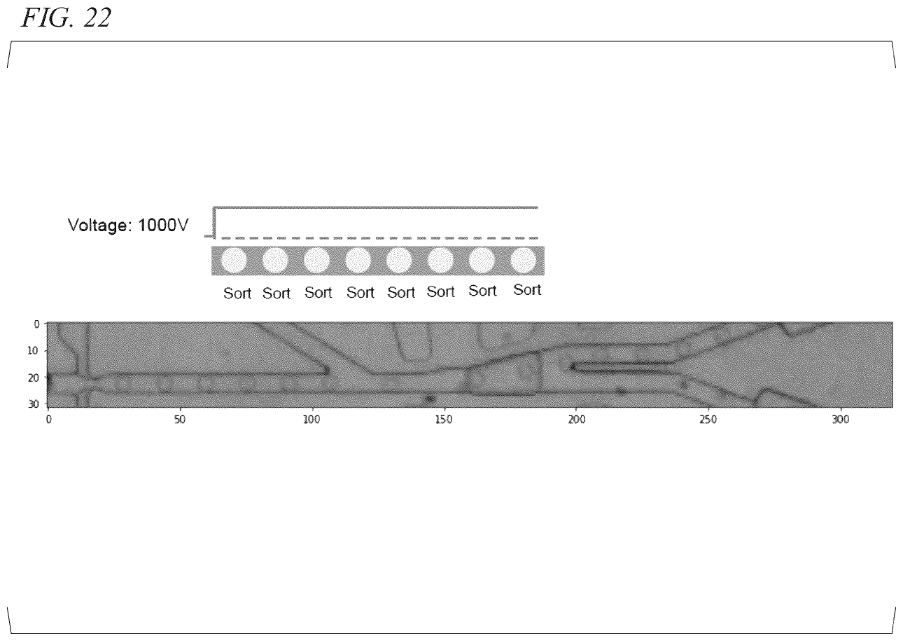

FIGS. 21 to 26 are views showing an example of a result of imaging a state of the separation. FIG. 21 is a result of imaging the state of the droplet D1 flowing through the microchannel 61 in a state in which a voltage is not applied to the electric field generation electrode 63. The droplet D1 flows toward the waste liquid side channel 613 without being crushed. On the other hand, FIG. 22 is a result of imaging the state of the droplet D1 flowing through the microchannel 61 in a state in which a voltage of 1,000 volts is applied to the electric field generation electrode 63. The droplet D1 flows toward the separation side channel 614 without being crushed. It is found that the droplets D1 flowing through the microchannel 61 at a high speed are separated by the dielectrophoretic force.

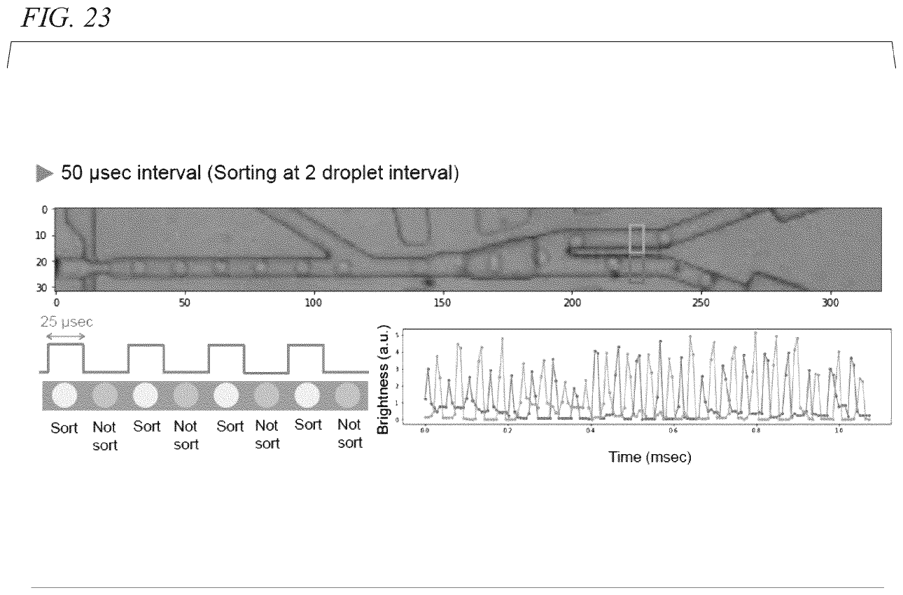

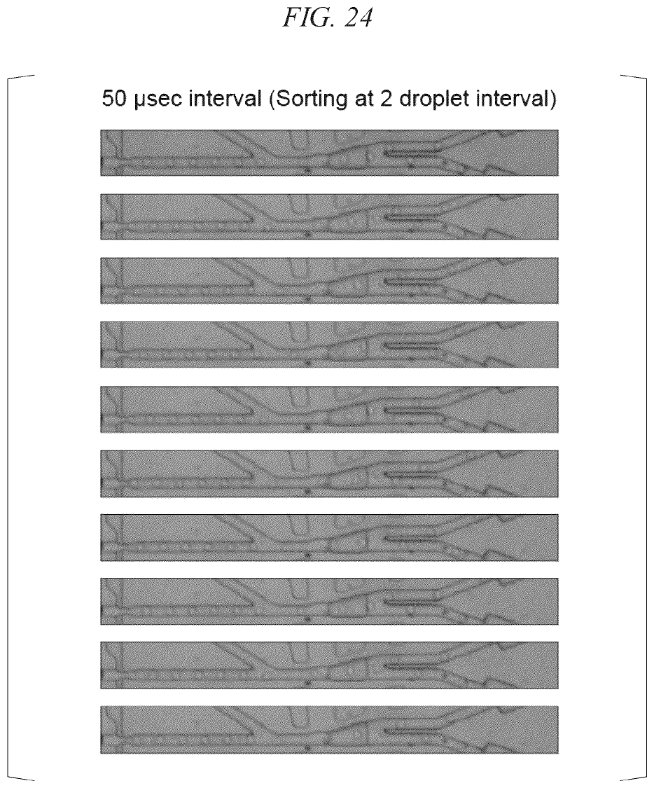

The result shown in FIG. 23 is a result of the separation at a time interval of 50 microseconds, and the time interval corresponds to a time interval at which the droplets D1 are separated every two droplets. FIG. 24 shows a time series of the captured images in a case where the droplets are separated at a time interval of 50 microseconds.

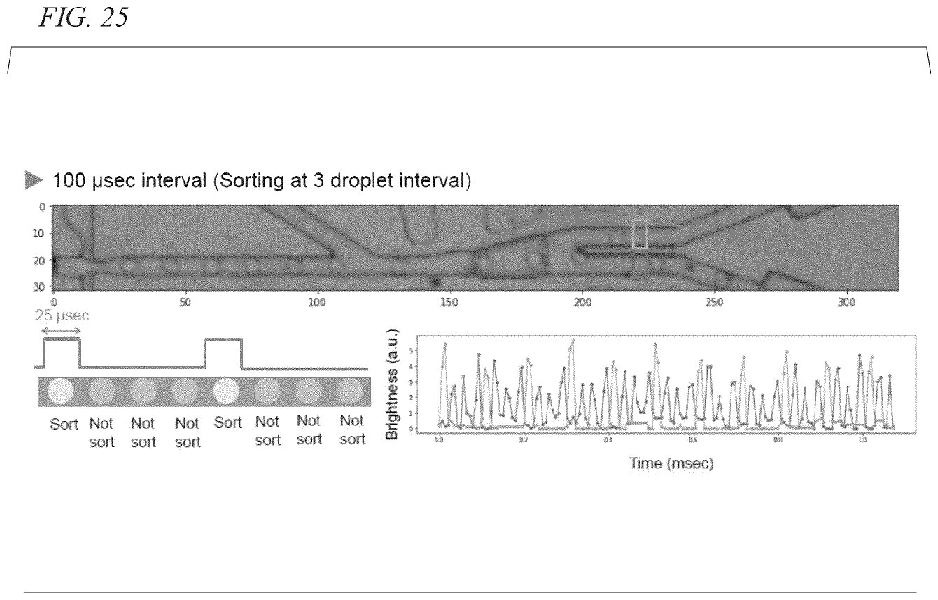

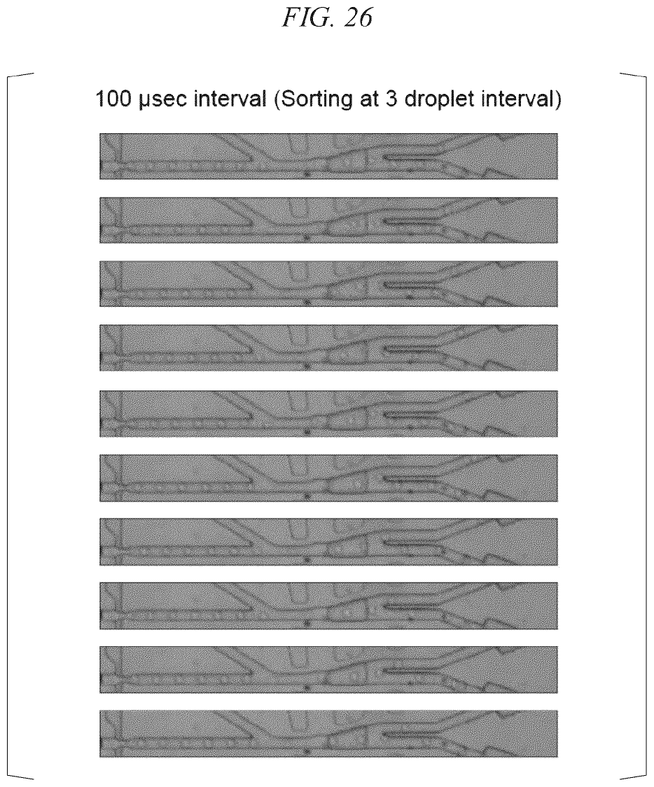

The result shown in FIG. 25 is a result of the separation at a time interval of 100 microseconds, and the time interval corresponds to a time interval at which the droplets D1 are separated every five droplets. FIG. 26 shows a time series of the captured images in a case where the droplets are separated at a time interval of 100 microseconds.

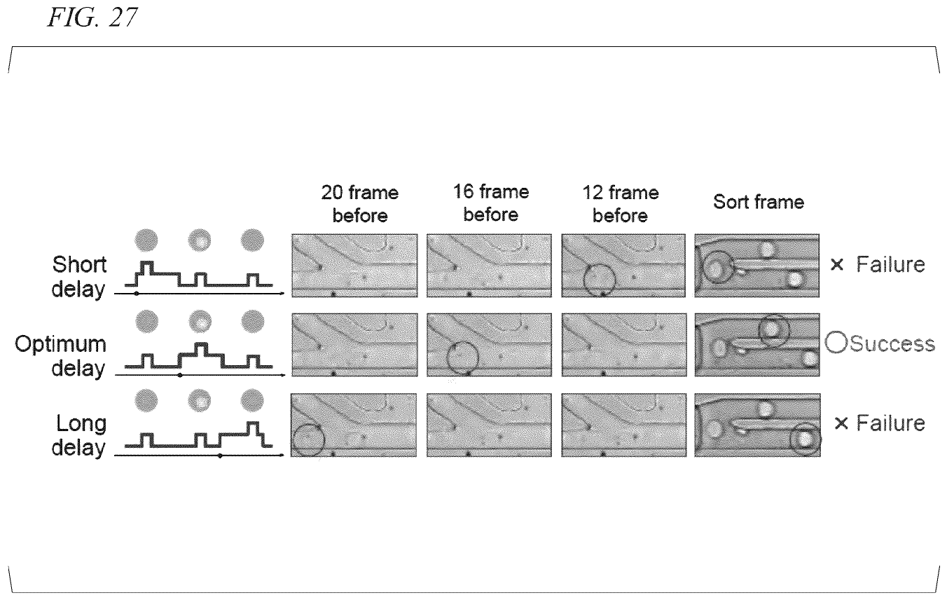

Next, a relationship between the separation timing and the separation performance will be described with reference to FIGS. 27 to 29. FIG. 27 shows a result of separation in a case where a time (referred to as a separation delay time) from the detection of the signal detection signal SS1 to the generation of the first trigger signal T1 is shifted. FIG. 27 shows images obtained by imaging the measurement sample A1 flowing through the microchannel chip 1, in each of a case where the separation delay time is appropriately adjusted, a case where the separation delay time is shortened from the appropriately adjusted separation delay time, and a case where the separation delay time is lengthened from the appropriately adjusted separation delay time. In the case where the separation delay time is appropriately adjusted, the separation is successful, but in the case where the separation delay time is shortened from the appropriately adjusted separation delay time and in the case where the separation delay time is increased from the appropriately adjusted separation delay time, the separation fails.

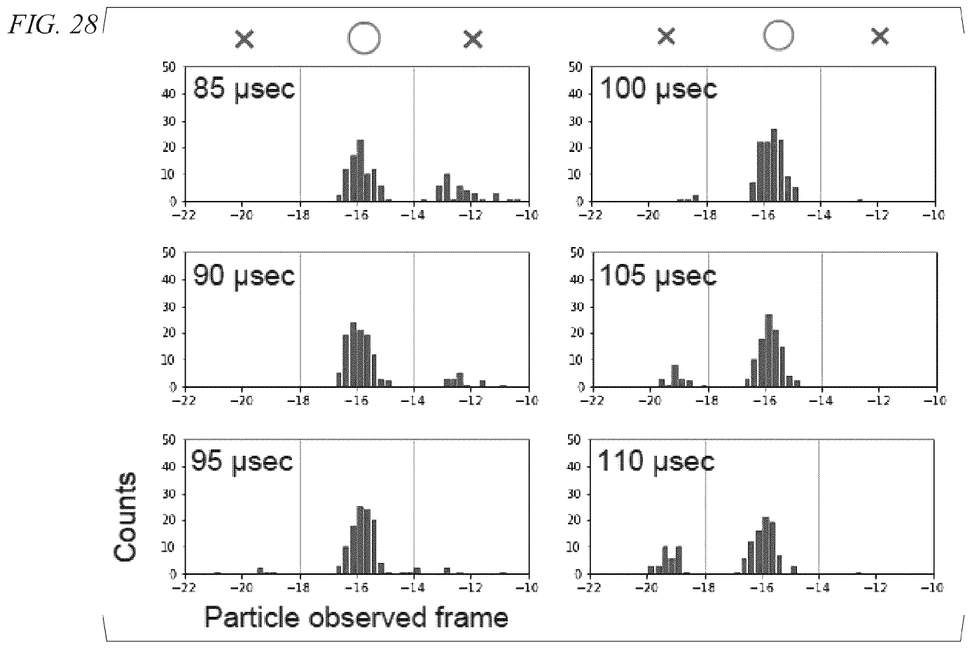

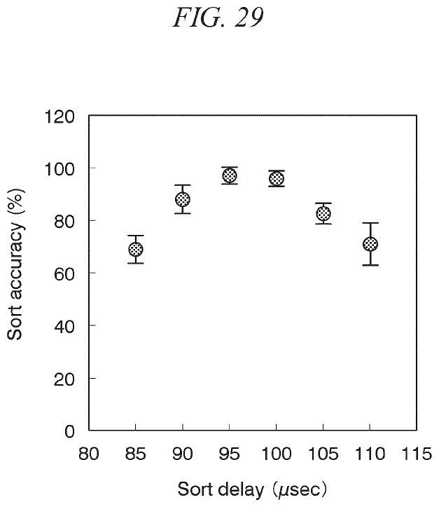

FIG. 28 is a histogram showing, for each measurement sample A1, how many frames before the frame in which the measurement sample A1 is detected is a frame from which the separation is performed in a case where the separation delay time is changed from 85 microseconds to 110 microseconds by 5 microseconds. FIG. 29 shows separation accuracy with respect to the separation delay time. The separation accuracy is a proportion of successful separation. It is found that a separation accuracy of 90% or more is achieved in a case where the separation delay time is approximately 95 microseconds.

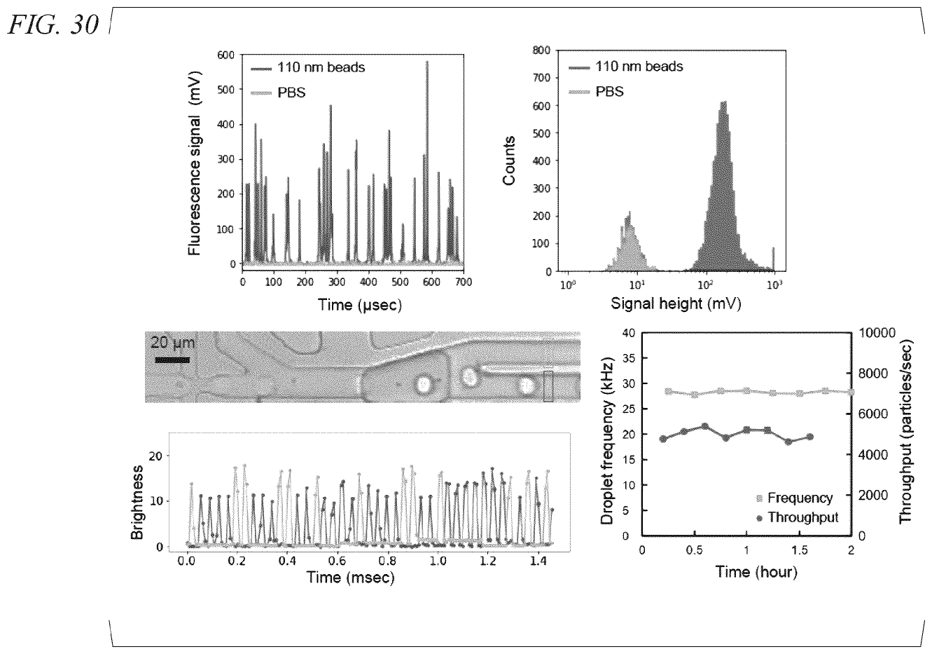

FIG. 30 shows results of separation of nanoparticles using the droplet detection device 10.

The results shown in FIG. 30 are results in which two types of nanoparticles, beads having a diameter of 110 nanometers and PbS nanoparticles, are used as the measurement sample A1. FIG. 30 shows a change in time of the detected signal of fluorescence, a distribution of the signal intensity, and a change in time of the brightness for each of the two types of nanoparticles. In addition, FIG. 30 shows a graph in which a change in time of the number of droplets generated per second is evaluated in units of frequency, and a graph showing a change in time of throughput (the number of nanoparticles separated per second) is shown. According to the graph showing the change in time of the throughput, it is found that approximately 5,000 nanoparticles can be separated per second.

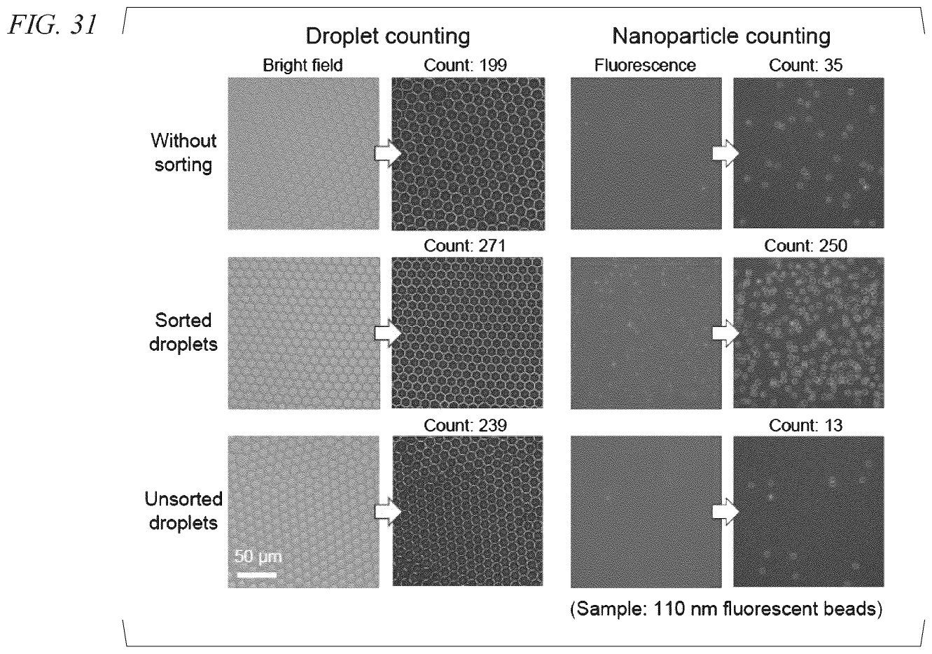

FIG. 31 shows results of evaluating the separation performance. The droplet D1 discharged from the separation side discharge port 8 to a test tube is collected, the collected droplet D1 is destroyed, and the nanoparticles (beads having a diameter of 110 nanometers) as the separation target A2 are taken out. The results shown in FIG. 31 are results of counting the collected droplet D1 and the separation target A2, respectively. Each counting result is a result for each of a case where the separation is not performed, a case where the separation is performed and is successful, and a case where the separation is performed but fails.

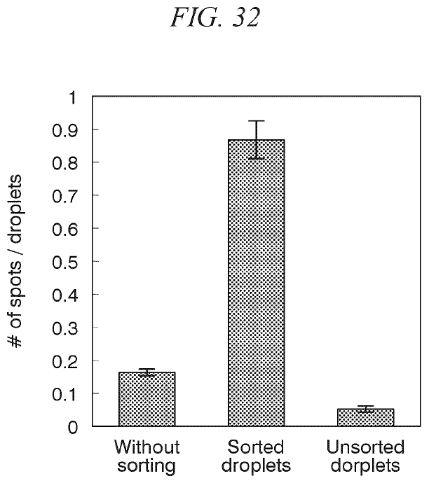

FIG. 32 shows a proportion of the number of counted separation targets A2 to the number of counted droplets D1 in each of the case where the separation is not performed, the case where the separation is performed and is successful, and the case where the separation is performed but fails. According to the results shown in FIG. 32, it is found that the droplet D1 containing the separation target A2 can be separated with an accuracy of 80% or more.

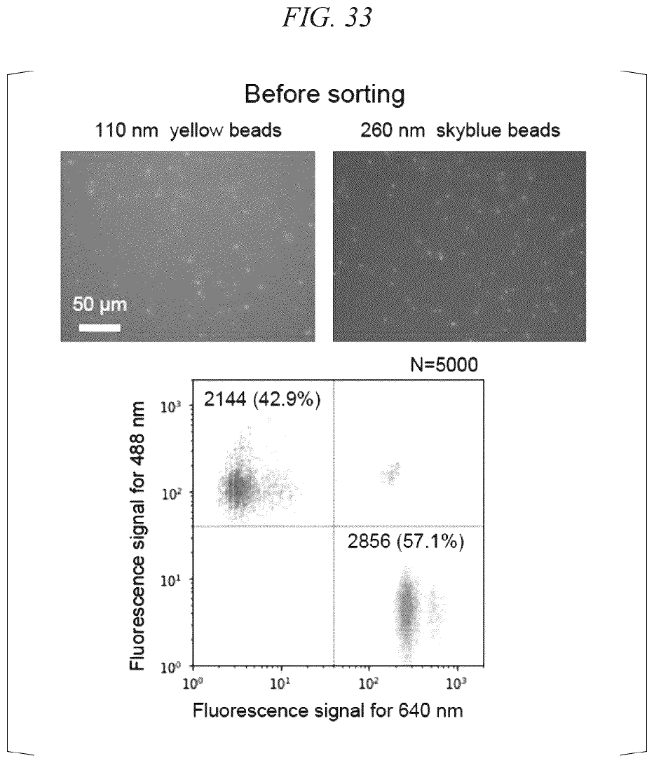

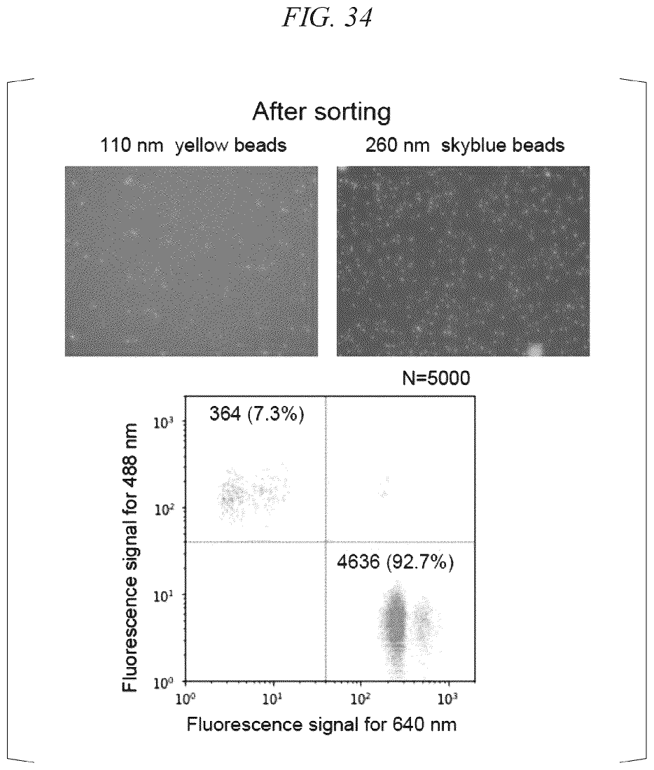

FIGS. 33 and 34 show detection results in a case where two types of nanoparticles are used as the measurement sample A1. The two types of nanoparticles used as the measurement sample A1 are yellow beads having a diameter of 110 nanometers and sky blue beads having a diameter of 260 nanometers. FIG. 33 shows results before the separation is performed. A wavelength of fluorescence emitted from the yellow beads is 640 nanometers. A wavelength of fluorescence emitted from the sky blue beads is 488 nanometers. The yellow beads are the separation target A2, and the sky blue beads are the non-separation target A3. The measurement sample A1 before the separation contains the yellow beads and the sky blue beads at a proportion of 1:1.

FIG. 34 shows results after the separation is performed. The results before the separation is performed are results based on the result of flowing the measurement sample A1 into the flow channel of the microchannel chip 1 and detecting fluorescence by the detection portion 212. The results after the separation is performed are results of collecting and destroying the droplet D1 separated by the droplet separation unit 6, and then flowing the measurement sample A1 contained in the droplet D1 again into the flow channel of the microchannel chip 1 and detecting fluorescence by the detection portion 212.

As shown in FIG. 33, before the separation is performed, the proportion of the yellow beads and the sky blue beads detected by fluorescence is 57.1% and 42.9%, respectively. On the other hand, as shown in FIG. 34, after the separation is performed, the proportion of the yellow beads and the sky blue beads detected by fluorescence is 92.7% and 7.3%, respectively. Therefore, it is found that the proportion of the yellow beads as the separation target A2 is increased by the separation, as compared with the case where the separation is not performed.

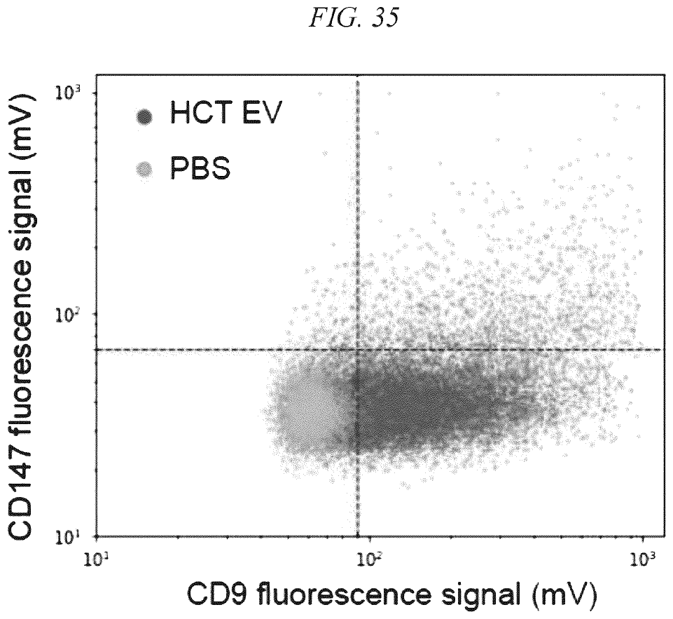

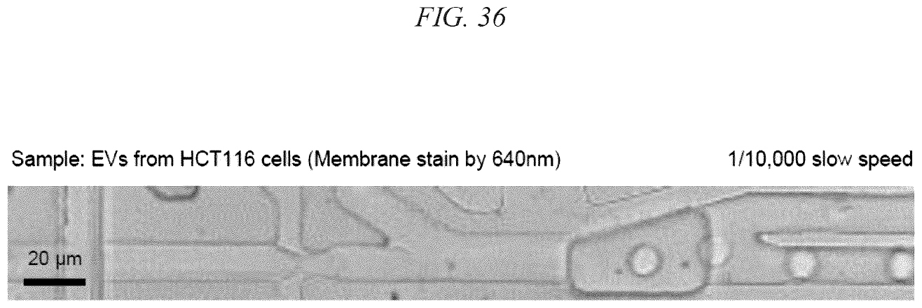

FIGS. 35 and 36 show results in a case where extracellular vesicles are separated by the droplet separation unit 6. In the result shown in FIG. 35, CD9 and CD147 contained in exosomes of human colorectal cancer cells (HCT116) are stained with fluorescence such that they emit fluorescence of 640 nanometers and 488 nanometers, respectively. The diameter of the exosome of HCT116 is approximately 100 nanometers to 200 nanometers. FIG. 35 is a scatter diagram in which signal intensities of fluorescence having two types of wavelengths emitted from each of CD9 and CD147 contained in the exosome of HCT116 are plotted. In FIG. 35, in addition to the result for the HCT 116, the result of the same measurement as the HCT 116 exosome for the PbS nanoparticles are shown for comparison.

FIG. 36 is an image obtained by imaging a state in which CD9 contained in the exosome of HCT116 is subjected to fluorescence staining so as to emit fluorescence of 640 nanometers, and the separation is performed based on the result of detecting the fluorescence as a signal.

As described above, the droplet separation device (in the present embodiment, the droplet separation unit 6) according to the present embodiment includes the microchannel 61, the droplet interval adjustment channel 62, the electric field generation electrode 63, and the plurality of the reference electrodes 64 (in the present embodiment, the first reference electrode 641, the second reference electrode 642, the third reference electrode 643, and the fourth reference electrode 644).

The microchannel 61 has the upstream portion 610, the chamber portion 611 which is provided downstream with respect to the upstream portion 610 and has a cross sectional area larger than a cross sectional area of the upstream portion 610, the branch portion 612 which is provided downstream with respect to the chamber portion 611, and two branch channels (in the present embodiment, the waste liquid side channel 613 and the separation side channel 614) which are branched by the branch portion 612, where the droplets D1 flow together with the first fluid (in the present embodiment, the first oil C1).

The droplet interval adjustment channel 62 is connected to the upstream portion 610 to join the upstream portion 610 and allows the second fluid (in the present embodiment, the second oil E1) having the same formulation as the first fluid (in the present embodiment, the first oil C1) to flow into the upstream portion 610.

The electric field generation electrode 63 is provided adjacent to the chamber portion 611, and generates an electric field by being controlled by an external signal to apply a voltage.

The plurality of the reference electrodes 64 (in the present embodiment, the first reference electrode 641, the second reference electrode 642, the third reference electrode 643, and the fourth reference electrode 644) are provided to generate the electric field gradient in the chamber portion 611 in accordance with the generation of the electric field by the electric field generation electrode 63.

The branch portion 612 has an asymmetric shape in which the droplet D1 flows into only one of the two branch channels (in the present embodiment, the waste liquid side channel 613 and the separation side channel 614) without being crushed in a case where the electric field generation electrode 63 does not generate an electric field.

With the configuration, the droplet separation device (in the present embodiment, the droplet separation unit 6) according to the present embodiment can separate the droplet D1 by a dielectrophoretic force while decelerating the droplet D1 in the chamber portion 611, and the droplet D1 can flow downstream of the chamber portion 611 without being crushed. Therefore, it is possible to achieve both high-speed droplet separation and accuracy of the separation. The high-speed droplet separation with a simple configuration is, for example, the separation of 10,000 or more droplets per second.

With the droplet separation device according to the embodiment of the present invention, since the fluid conditions, the fluid structure, and the electrode arrangement are such that the droplets can be separated without being crushed by applying a voltage in a short amount of time, it is possible to separate 30,000 or more droplets per second. The droplet separation unit 6 which is the droplet separation device may be provided in a microchannel other than the microchannel chip 1 according to the present embodiment.

In addition, the separation signal generation device 11 according to the present embodiment includes the first trigger signal generation unit 111, the second trigger signal generation unit 113, the determination unit 114, and the separation signal output unit 115.

The first trigger signal generation unit 111 generates the first trigger signal T1 at the time when the separation target A2 wrapped in the droplet and flows through the microchannel 61 together with the first fluid (in the present embodiment, the first sheath liquid B1) is detected.

The second trigger signal generation unit 113 generates the second trigger signal T2 at the time when the droplet D1 flowing through the microchannel 61 passes through a predetermined position in the flow velocity direction of the microchannel 61.

The determination unit 114 determines whether or not the determination signal T3 which is the sum of the first trigger signal T1 and the second trigger signal T2 is equal to or more than a predetermined threshold value.

In a case where the determination signal T3 is equal to or more than the threshold value, the separation signal output unit 115 outputs the separation signal T4 for separating the separation target A2.

With the configuration, the separation signal generation device 11 according to the present embodiment can determine the timing of the signal separation based on the timing when the signal of the separation target A2 is detected and the timing when the droplet D1 is generated, and thus, the accuracy of the signal separation can be improved. As described above, in the microchannel chip 1 according to the present embodiment, after the separation target A2 is detected, the droplet D1 wrapping the separation target A2 is formed. Here, the timing when the desired separation target A2 is detected among the measurement samples A1 flowing through the sample channel 21 at a high speed is not determined in advance. On the other hand, although the period in which the droplet D1 is generated is almost constant, the droplets D1 are generated at a very high frequency of 30,000 or more droplets per second. Consequently, in the related art, it is difficult to determine the timing of separating the droplet D1 containing the separation target A2 after the separation target A2 is detected.

Each unit included in each device (the measurement sample detection device 9, the droplet detection device 10, and the separation signal generation device 11) in the above-described embodiments may be realized by dedicated hardware, or may be realized by a memory and a microprocessor.

Each unit provided in each device may be configured by a memory and a central processing unit (CPU), and the function of each unit provided in each device may be realized by loading and executing a program for realizing the function in the memory.

In addition, a program for realizing the function of each unit included in each device may be recorded on a computer-readable recording medium, and the program recorded on the recording medium may be loaded into the computer system and executed to perform the processing by each unit included in a controller. A term “computer system” herein includes an OS and hardware such as a peripheral device.

In addition, the “computer system” also includes a homepage providing environment (or a display environment) in a case where a WWW system is used. In addition, the “computer-readable recording medium” refers to a portable medium such as a flexible disk, a magneto-optical disk, a ROM, and a CD-ROM, and a storage device such as a hard disk built in the computer system. Furthermore, the “computer-readable recording medium” includes a medium which dynamically holds the program for a short period of time as in a communication line in a case where the program is transmitted through a network such as the Internet or a communication line such as a telephone line, and a medium which holds the program for a certain period of time as in a volatile memory inside the computer system serving as a server or a client in that case. In addition, the program may be a program realizing a part of the functions described above, further, the functions described above may be realizable by combining with the program already recorded in the computer system.

The embodiments of the present invention has been described in detail above with reference to the drawings, but the specific configurations are not limited to those described above, and various design changes, and the like are possible within the scope that does not deviate from the gist of the present invention.

### REFERENCE SIGNS LIST

1 Microchannel chip
6 Droplet separation unit
61 Microchannel
62 Droplet interval adjustment channel
63 Electric field generation electrode
64 Reference electrode
610 Upstream portion
611 Chamber portion
612 Branch portion
613 Waste liquid side channel
614 Separation side channel
C1 First oil
E1 Second oil
D1 Droplet
A2 Separation target
11 Separation signal generation device
111 First trigger signal generation unit
113 Second trigger signal generation unit
114 Determination unit
115 Separation signal output unit
T1 First trigger signal
T2 Second trigger signal
T3 Determination signal
T4 Separation signal

1. A droplet separation device comprising:
a microchannel that has an upstream portion, a chamber portion which is provided downstream with respect to the upstream portion and has a cross sectional area larger than a cross sectional area of the upstream portion, a branch portion which is provided downstream with respect to the chamber portion, and two branch channels which are branched by the branch portion, where droplets flow together with a first fluid;
a droplet interval adjustment channel that is connected to the upstream portion to join the upstream portion and allows a second fluid having the same formulation as the first fluid to flow into the upstream portion;
an electric field generation electrode that is provided to be adjacent to the chamber portion and generates an electric field by being controlled by an external signal to apply a voltage; and
a plurality of reference electrodes that are provided to generate an electric field gradient in the chamber portion in accordance with the generation of the electric field by the electric field generation electrode,
wherein the branch portion has an asymmetric shape in which the droplets flow into only one of the two branch channels without being crushed in a case where the electric field generation electrode generates no electric field.

2. The droplet separation device according to claim 1,
wherein, a distance between a connecting portion where the droplet interval adjustment channel is connected to the upstream portion and the chamber portion is a distance obtained by multiplying an interval between the droplets on an upstream side of the upstream portion with respect to the connecting portion by a ratio of a flow rate at the upstream side of the upstream portion with respect to the connecting portion and a flow rate at a downstream side of the upstream portion with respect to the connecting portion.

3. The droplet separation device according to claim 1,
wherein a width of an inlet portion which is a portion of the chamber portion on a most upstream side is approximately equal to a diameter of the droplets, and a width of an outlet portion which is a portion of the chamber portion on a most downstream side is approximately equal to a sum of twice the diameter of the droplets and a width of the branch portion.

4. The droplet separation device according to claim 1,
wherein a cross sectional area of the chamber portion is a cross sectional area corresponding to a cross sectional area of the upstream portion and a flow rate of the second fluid which is allowed to flow into the upstream portion by the droplet interval adjustment channel.

5. The droplet separation device according to claim 1,
wherein a length of the chamber portion is a length which is determined according to a flow velocity at a downstream side of the upstream portion with respect to a connecting portion where the droplet interval adjustment channel is connected to the upstream portion, in which the number of the droplets flowing through the chamber portion at the same time is 1 in terms of time average.

6. The droplet separation device according to claim 1,
wherein a width of the branch portion is approximately equal to or less than a diameter of the droplets.

7. The droplet separation device according to claim 1,
wherein, as a shape of a portion of the branch portion on a most upstream side, a portion on one side of the two branch channels, where the droplets flow in the case where the electric field generation electrode generates no electric field, is curved.

8. The droplet separation device according to claim 1,
wherein a tip part of the electric field generation electrode and a first side surface of the chamber portion face each other, an orientation of a surface of the tip part is substantially parallel to an orientation of the first side surface, and an area of the surface of the tip part is approximately equal to an area of the first side surface.

9. The droplet separation device according to claim 1,
wherein a part of the plurality of the reference electrodes is provided adjacent to the electric field generation electrode on a side of the microchannel on which the electric field generation electrode is provided, and a remaining part of the plurality of the reference electrodes is provided on a side of the microchannel on which no electric field generation electrode is provided.

10. The droplet separation device according to claim 1,
wherein a width of the microchannel is approximately equal to a diameter of the droplets in a portion other than the chamber portion.

11. A separation signal generation device comprising:
a memory; and
a central processing unit connected to the memory and that:
generates a first trigger signal at a time when a separation target is detected, the separation target being wrapped in a droplet and flowing through a microchannel together with a first fluid;
generates a second trigger signal at a time when the droplet flowing through the microchannel passes through a predetermined position in a flow velocity direction of the microchannel;
determines whether or not a determination signal which is a sum of a magnitude of the first trigger signal and a magnitude of the second trigger signal is equal to or more than a predetermined threshold value; and
outputs a separation signal for separating the separation target in a case where the determination signal is equal to or more than the threshold value.

12. The separation signal generation device according to claim 11,
wherein the passing of the droplet flowing through the microchannel through the position in the flow velocity direction of the microchannel is detected based on scattered light from the droplet flowing through the microchannel.

13. A separation signal generation method comprising:
generating a first trigger signal at a time when a separation target is detected, the separation target being wrapped in a droplet and flowing through a microchannel together with a first fluid;
generating a second trigger signal at a time when the droplet flowing through the microchannel passes through a predetermined position in a flow velocity direction of the microchannel;
determining whether or not a determination signal which is a sum of a magnitude of the first trigger signal and a magnitude of the second trigger signal is equal to or more than a predetermined threshold value; and
determining a separation signal for separating the separation target in a case where the determination signal is equal to or more than the threshold value.

14. A non-transitory computer readable medium storing a program causing a computer to execute:
generating a first trigger signal at a time when a separation target is detected, the separation target being wrapped in a droplet and flowing through a microchannel together with a first fluid;
generating a second trigger signal at a time when the droplet flowing through the microchannel passes through a predetermined position in a flow velocity direction of the microchannel;
determining whether or not a determination signal which is a sum of a magnitude of the first trigger signal and a magnitude of the second trigger signal is equal to or more than a predetermined threshold value; and
outputting a separation signal for separating the separation target in a case where the determination signal is equal to or more than the threshold value.
